(19) United States
(12) Patent Application Publication
(10) Pub. No.: US 2026/0323624 A1
(43) Pub. Date: Oct. 15, 2026

(54) TERMINAL DEVICE, BASE STATION, AND COMMUNICATION METHOD

(71) Applicant: Sony Group Corporation, Tokyo (JP)

(72) Inventor: Naoyuki TOYODA, Tokyo (JP)

(73) Assignee: Sony Group Corporation, Tokyo (JP)

(21) Appl. No.: 19/473,821

(22) PCT Filed: Apr. 16, 2024
(86) PCT No.: PCT/JP2024/015117

§ 371 Date: Oct. 9, 2025

(30) Foreign Application Priority Data
Apr. 25, 2023 (JP) 2023-071712

(51) Int. Cl. H04W 72/12; H04W 24/10; H04W 28/02; H04W 72/21

(52) U.S. Cl. CPC H04W 72/1221; H04W 24/10; H04W 28/0278; H04W 72/21

(57) ABSTRACT

A terminal device includes circuitry that circuitry configured to determine a maximum residence time of packets stored in a packet buffer of the terminal device, and that transmits residence information, including the maximum residence time, to a base station device with which the terminal device communicates.

### TECHNICAL FIELD

The present disclosure relates to a terminal device, a base station, and a communication method.

### BACKGROUND Art

In recent years, a mobile network (e.g., a cellular network such as 5G) is required to have high communication performance (e.g., connection stability, low delay, high reliability, high throughput, power saving, low processing load, and the like). Among them, the low delay is a very important factor in realizing a new communication service that has appeared in recent years (e.g., device control in Internet of Things (IoT), real-time communication in a game or virtual reality (VR), and the like).

### CITATION LIST

### Patent Literature

PTL 1: JP 2012-34407 A

### SUMMARY

### Technical Problem

One of the factors causing a delay is a scheduling standby time in a base station. In downlink communication, a residence time of a packet can be grasped on the network side (e.g., a core network and/or a base station). Therefore, it is assumed that the base station can perform scheduling for downlink communication so as to satisfy the delay requirement. However, in uplink communication, the base station cannot grasp a residence time of a packet in the terminal device. For this reason, it is not easy for the base station to schedule the uplink communication so as to satisfy the delay requirement.

Therefore, the present disclosure proposes a terminal device, a base station, and a communication method capable of realizing low-delay wireless communication.

Note that the aforementioned problem or object is merely one of a plurality of problems or problems or objects that can be solved or achieved by a plurality of embodiments disclosed in the present specification.

### Solution to Problem

In order to solve the above problem, an exemplary aspect of the present disclosure includes a terminal device including circuitry that determines a maximum residence time of packets stored in a packet buffer of the terminal device, and transmits residence information, including the maximum residence time, to a base station device with which the terminal device communicates.

In another exemplary aspect, a base station device includes circuitry that receives residence information from a terminal device with which the base station device communicates, the residence information including at least a maximum residence time of packets stored in the terminal device, and notifies the terminal device of at least one scheduling grant based on the maximum residence time.

In a further exemplary aspect, a method for a terminal device that communicates with a base station device includes determining, with circuitry, a maximum residence time of packets stored in a packet buffer of the terminal device, and transmitting residence information, including the maximum residence time, to the base station device.

In a still further exemplary aspect, a method for a base station device that communicates with a terminal device, includes receiving, with circuitry, residence information from the terminal device, the residence information including at least a maximum residence time of packets stored in the terminal device, and notify the terminal device of at least one scheduling grant based on the maximum residence time.

### BRIEF DESCRIPTION OF DRAWINGS

FIG. 1 is a partial excerpt of TS 23.501 Table 5.7.4-1 of 3GPP.

FIG. 2 is a diagram for explaining scheduling in downlink communication.

FIG. 3 is a diagram for explaining scheduling in downlink communication.

FIG. 4 is a diagram illustrating a configuration of a communication system according to the present embodiment.

FIG. 5 is a diagram illustrating an example of a configuration of a server according to an embodiment of the present disclosure.

FIG. 6 is a diagram illustrating a configuration of a management device according to the present embodiment.

FIG. 7 is a diagram illustrating a configuration of a base station according to the present embodiment.

FIG. 8 is a diagram illustrating a configuration of a terminal device according to the present embodiment.

FIG. 9 is a functional block diagram of a terminal device according to a first embodiment.

FIG. 10 is a diagram illustrating an example of a format of a BSR in which residence time information can be stored.

FIG. 11 is a diagram illustrating an example of a format of a BSR in which residence time information can be stored.

FIG. 12 is a diagram illustrating another example of a format of a BSR in which residence time information can be stored.

FIG. 13 is a diagram illustrating another example of a format of a buffer status report (BSR) in which residence time information can be stored.

FIG. 14 is a sequence diagram illustrating communication processing according to the first embodiment.

FIG. 15 is a diagram for explaining scheduling in consideration of a residence time.

FIG. 16 is a functional block diagram of a terminal device according to a second embodiment.

FIG. 17 is a functional block diagram of a base station according to the second embodiment.

FIG. 18 is a diagram illustrating an example of a format of a PDU in which a time stamp can be stored.

FIG. 19 is a diagram for explaining delay time-measurable granularity.

FIG. 20 is a sequence diagram illustrating communication processing according to the second embodiment.

FIG. 21 is a diagram for explaining scheduling in consideration of a delay time.

FIG. 22 is a functional block diagram of a communication system according to a third embodiment.

FIG. 23 is a functional block diagram of a terminal device according to the third embodiment.

FIG. 24 is a functional block diagram of a server according to the third embodiment.

FIG. 25 is a sequence diagram illustrating communication processing according to the third embodiment.

FIG. 26 is a sequence diagram for explaining a method of specifying a residence time.

FIG. 27 is a diagram for explaining an external device.

FIG. 28 is a diagram illustrating an example of an open radio access network (O-RAN) architecture.

FIG. 29 is a sequence diagram illustrating communication processing using O-RAN.

### DESCRIPTION OF EMBODIMENTS

Hereinafter, embodiments of the present disclosure are described in detail with reference to the drawings. Note that, in the following embodiments, the same parts will be denoted by the same reference signs, and redundant description will be omitted.

In addition, in the present specification and the drawings, a plurality of components having substantially the same functional configuration may be distinguished from each other by attaching different alphabets or numbers after the same reference sign. For example, a plurality of components having substantially the same functional configuration are distinguished from each other, as necessary, like terminal devices 40₁, 40₂, and 40₃. However, in a case where it is not necessary to particularly distinguish a plurality of components having substantially the same functional configuration from each other, only the same reference sign will be attached thereto. For example, in a case where it is not necessary to particularly distinguish the terminal devices 40₁, 40₂, and 40₃, they will be simply referred to as terminal devices 40.

One or more embodiments (including examples and modifications thereof) to be described below can be implemented each independently. On the other hand, at least some of the plurality of embodiments to be described below may be appropriately combined with at least some of the other embodiments. The plurality of embodiments may include novel features different from each other. Therefore, the plurality of embodiments can contribute to solving different objects or problems, and can cause different effects.

### 1. Outline

Before describing the present embodiment in detail, an outline of the present embodiment will be described.

### 1-1. Problem

In recent years, a mobile network (e.g., a cellular network such as 5G) is required to have high communication performance (e.g., connection stability, low delay, high reliability, high throughput, power saving, low processing load, and the like). Among them, the low delay is a very important factor in realizing a new communication service that has appeared in recent years (e.g., device control in IoT, real-time communication in a game or VR, and the like).

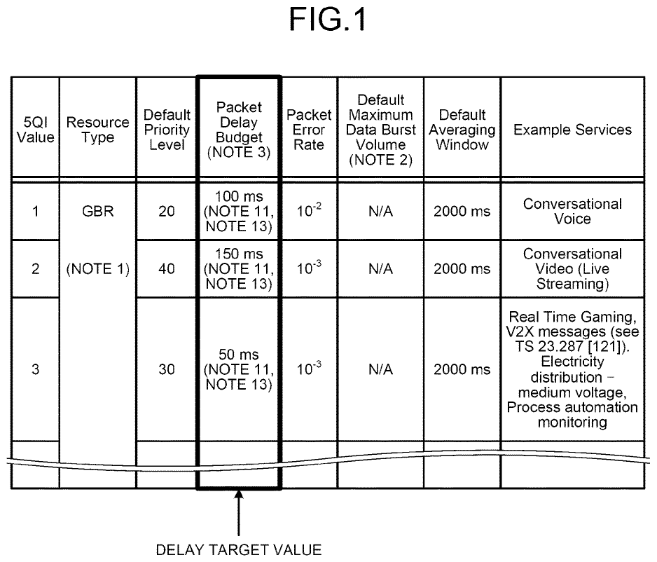

One of factors that cause a delay is a scheduling standby time in a medium access control (MAC) scheduler in a base station. This occurs because one-time transmittable/multiplexable amount is limited depending on a system bandwidth and a radio wave propagation environment of a terminal device. In particular, concerning a service (e.g., bearer, slice, session, quality of service (QOS) flow, or the like) for which a packet delay budget (PDB) is defined in a service level agreement (SLA) or the like, the base station needs to perform scheduling not to exceed the PDB (hereinafter also simply referred to as delay budget). FIG. 1 is a partial excerpt of TS 23.501 Table 5.7.4-1 of 3GPP (registered trademark). In a cellular network, a delay target value of a service is set as quality of service (QOS) information in a core network/base station (gNB/eNB).

For the downlink (DL), a residence time of each packet can be measured on the network side (e.g., a core network and/or a base station). Therefore, it is assumed that the base station can perform scheduling so that a residence time of a packet does not exceed a delay budget defined in the SLA or the like.

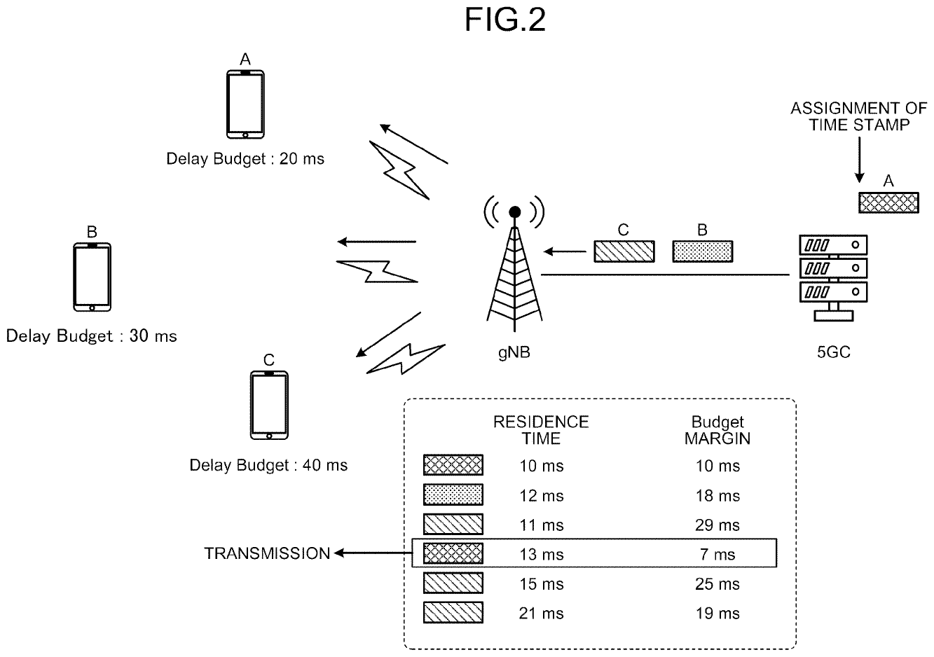

FIG. 2 is a diagram for explaining scheduling in downlink communication. In an example of FIG. 2, three terminal devices (A, B, and C illustrated in FIG. 2) are connected to a base station (gNB in the example of FIG. 2). The base station receives a packet for each terminal device from the core network (5GC in the example of FIG. 2). A time stamp or the like is assigned to the packet received by the base station from the core network at an entrance of the core network. The base station calculates a residence time of each packet based on a time stamp. In FIG. 2, a plurality of packets held in a gNB DL radio link control (RLC) buffer, and a residence time and a budget margin time for each of the plurality of packets are illustrated. Then, the base station performs scheduling based on residence time information. In the example of FIG. 2, the packet for the terminal device A having a residence time of 13 ms has the smallest margin in delay budget. Therefore, the base station performs scheduling for transmission from the packet for the terminal device A.

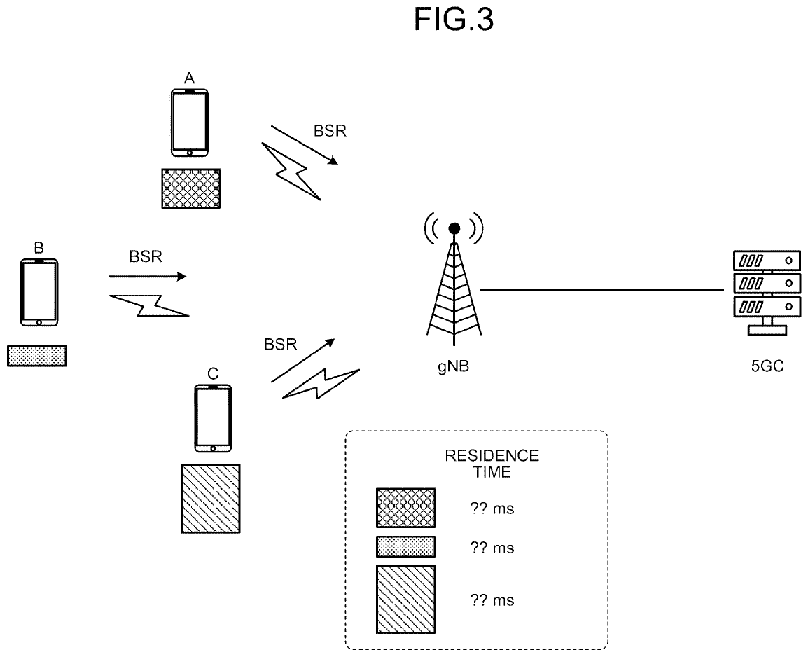

In the uplink (UL) as well, it is expected that scheduling is executed based on a delay time in consideration of a delay budget defined in a service level agreement (SLA) or the like. FIG. 3 is a diagram for explaining scheduling in downlink communication. At present, the terminal device notifies the base station of a total amount of residence in the buffer for each logical channel group (LCG) by a buffer status report (BSR). However, the terminal device does not notify the base station of information indicating how long each packet is held in the terminal device. There is a possibility that the base station may be able to determine a time taken for a packet to be processed after the buffer is in the O state. However, this is insufficient for SLA. That is, in the uplink communication, the base station cannot grasp a residence time of a packet in the terminal device. For this reason, it is not easy for the base station to schedule the uplink communication so as to satisfy the delay requirement.

### 1-2. Outline of Solution

Therefore, the present embodiment solves the aforementioned problem as follows.

For example, the terminal device according to the present embodiment measures residence times of one or more uplink packets transmitted to the base station for the respective packets, and specifies a maximum value of the residence times. For example, when transmitting a BSR, the terminal device specifies a maximum residence time (e.g., a residence time in the terminal device/a residence time in the RLC buffer) among radio link control protocol data units (RLC PDUs) staying in the LCG. Then, the terminal device transmits residence time information including at least information on the maximum value of the residence times to the base station. For example, the terminal device provides a new area for storing the residence time information in the BSR, and stores the residence time information in the area. Then, the terminal device transmits the BSR in which the residence time information is stored to the base station. The base station extracts the residence time information from the received BSR. Then, the base station performs scheduling for uplink communication based on the residence time information.

Therefore, the base station can schedule uplink communication so as to satisfy the delay requirement. As a result, since low-delay wireless communication is realized in uplink communication as well, the base station and the terminal device can realize wireless communication with high communication performance (e.g., stable low-delay wireless communication).

Although the outline of the present embodiment has been described above, a communication system 1 according to the present embodiment will be described in detail below.

### 2. Configuration of Communication System

First, a configuration of the communication system 1 will be specifically described. The configuration of the communication system 1 to be described below is common to first to third embodiments.

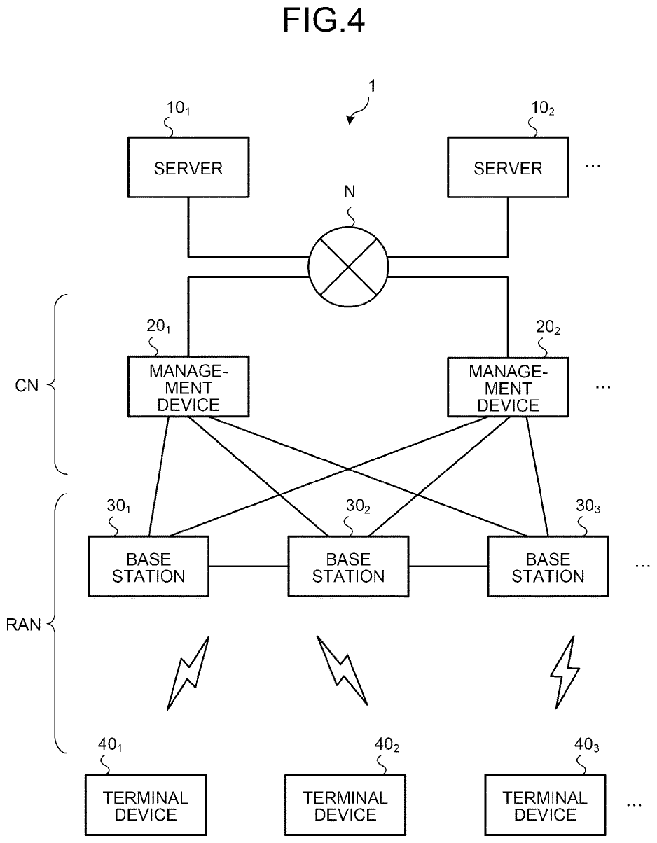

FIG. 4 is a diagram illustrating the configuration of the communication system 1 according to the present embodiment. The communication system 1 includes a server 10, a management device 20, a base station 30, and a terminal device 40. The communication system 1 provides a wireless network (mobile network) capable of mobile communication to a user by operating wireless communication devices constituting the communication system 1 in cooperation with each other. The wireless network in the present embodiment may be, for example, a cellular network including a radio access network RAN and a core network CN. The mobile network may include a terminal device 40. In the present embodiment, the wireless communication devices are devices each having a wireless communication function, and corresponds to the base station 30 and the terminal device 40 in the example of FIG. 4.

The communication system 1 may include a plurality of servers 10, a plurality of management devices 20, a plurality of base stations 30, and a plurality of terminal devices 40. In the example of FIG. 4, the communication system 1 includes a server 10₁ and a server 10₂ as the servers 10, and includes a management device 20₁ and a management device 20₂ as the management devices 20. Furthermore, the communication system 1 includes a base station 30₁, a base station 30₂, and a base station 30₃ as the base stations 30, and includes a terminal device 40₁, a terminal device 40₂, and a terminal device 40₃ as the terminal devices 40.

The terminal devices 40 may be configured to be connected to a network using a radio access technology (RAT) such as long term evolution (LTE), new radio (NR), 6G, Wi-Fi, or Bluetooth (registered trademark). At this time, the terminal devices 40 may be configured to be able to use different radio access technologies (wireless communication schemes). For example, the terminal devices 40 may be configured to be able to use NR and Wi-Fi. Furthermore, the terminal devices 40 may be configured to be able to use different cellular communication technologies (e.g., LTE, NR, and 6G). In the following description, the terminal devices 40 may be referred to as user equipment (UE).

LTE and NR, which are types of cellular communication technologies, enable terminal devices to perform mobile communication by arranging a plurality of areas covered by base stations in the form of cells. In addition, 6G, which is also a type of cellular communication technology, may be a technology that enables terminal devices to perform mobile communication by arranging a plurality of areas covered by base stations in the form of cells.

Note that, in the following description, “LTE” includes LTE-Advanced (LTE-A), LTE-Advanced Pro (LTE-A Pro), and evolved universal terrestrial radio access (EUTRA). In addition, NR includes new radio access technology (NRAT) and further EUTRA (FEUTRA). Note that a single base station 30 may manage a plurality of cells. In the following description, a cell corresponding to LTE will be referred to as an LTE cell, and a cell corresponding to NR will be referred to as an NR cell.

NR is a radio access technology of a next generation (fifth generation) of LTE (fourth generation communication including LTE-Advanced and LTE-Advanced Pro). NR is a radio access technology that can correspond to various use cases including enhanced mobile broadband (eMBB), massive machine type communications (mMTC), and ultra-reliable and low latency communications (URLLC). NR was established as a standard in Rel-15 of 3GPP (registered trademark) as a technical framework corresponding to usage scenarios, requirements, arrangement scenarios, and the like in these use cases. Furthermore, in Beyond 5G and 6G, it is required to simultaneously realize a plurality of axes with high speed and large capacity, low delay and high reliability, and multiple simultaneous connections.

6G is a cellular communication technology of a next generation of NR or 5G system (5GS) which is fifth generation communication for a mobile object. 6G includes a radio access technology and a network technology between a base station, a core network, and a data network. In addition, 6G includes a technology for extreme connectivity of each of eMBB, mMTC, and URLLC, which has been considered as a main use case or a requirement in NR. In addition, 6G includes new technologies in new aspects. For example, 6G may include technologies related to AI (a cognitive network and an AI native air interface) and sensing (radar sensing and a network as a sensor), and terahertz communication.

Note that the wireless network may correspond to at least one of radio access technologies (RAT) such as long term evolution (LTE), new radio (NR), and 6G. LTE, NR, and 6G, which are types of cellular communication technologies, enable terminal devices to perform mobile communication by arranging a plurality of areas covered by base stations in the form of cells. Note that the radio access scheme used by the communication system 1 is not limited to LTE, NR, or 6G, and may be another radio access scheme such as wideband code division multiple access (W-CDMA) or code division multiple access 2000 (cdma2000).

Furthermore, the base station 30 may be a ground station or a non-ground station. The non-ground station may be a satellite station or an aircraft station. If the non-ground station is a satellite station, the wireless network may be a bent-pipe (transparent) type mobile satellite communication system.

In the present embodiment, the ground station or the ground base station refer to a base station or a relay station installed on the ground. Here, the “ground” is a ground in a broad sense, including not only on land but also under ground, on water, and under water. Note that, in the following description, the term “ground station” may be replaced with “gateway”.

Note that an LTE base station may be referred to as an evolved node B (eNodeB) or an eNB. Further, an NR base station may be referred to as a gNodeB or a gNB. In addition, a 6G base station may be referred to as a 6G NodeB (6GNB). In LTE, NR, and 6G, a terminal device (also referred to as a mobile station or a terminal) may be referred to as user equipment (UE). Note that the terminal device, which is a type of communication device, and is also referred to as a mobile station or a terminal.

Note that the terminal device 40 may be connectable to a network using a radio access technology (wireless communication scheme) other than LTE, NR, 6G, Wi-Fi, and Bluetooth. For example, the terminal device 40 may be connectable to a network by using low power wide area (LPWA) communication. Furthermore, the terminal device 40 may be connectable to a network using wireless communication with a proprietary standard.

Here, the LPWA communication is wireless communication that enables low-power wide-range communication. For example, the LPWA radio is Internet of Things (IoT) wireless communication using a specific low power radio (e.g., a 920 MHz band) or an industry-science-medical (ISM) band. Note that the LPWA communication used by the terminal device 40 may conform to the LPWA standard. Examples of the LPWA standard include ELTRES, ZETA, SIGFOX, LoRaWAN, and NB-Iot. Of course, the LPWA standard is not limited thereto, and may be another LPWA standard.

Each wireless communication device illustrated in FIG. 4 may be considered as a device in a logical sense. That is, a part of each wireless communication device may be realized by a virtual machine (VM), a container such as a docker, and the like, and they may be implemented on the physically same hardware.

In the present embodiment, the concept of the wireless communication device includes not only a portable mobile device (terminal device) such as a mobile terminal but also a device installed in a structure or a mobile object. The structure or the mobile object itself may be regarded as a wireless communication device. Furthermore, the concept of the wireless communication device includes not only the terminal device 40 but also the base station 30. The wireless communication device is a type of processing device or information processing device. The wireless communication device can also be referred to as a transmission device or a reception device.

Hereinafter, a configuration of each of the wireless communication devices constituting the communication system 1 will be specifically described. Note that the configuration of each wireless communication device to be described below is merely an example. The configuration of each wireless communication device may be different from the configuration to be described below.

### 2-1. Configuration of Server

First, a configuration of the server 10 will be described.

The server 10 is an information processing device (computer) that provides various services to the terminal device 40. For example, the server 10 is an application server or a web server. The server 10 may be a PC server, a midrange server, or a mainframe server. Furthermore, the server 10 may be an information processing device that performs data processing (edge processing) near the user or the terminal. For example, the server 10 may be an information processing device (computer) attached to or built in a base station. Of course, the server 10 may be an information processing device that performs cloud computing. The server 10 according to the present embodiment can function as an application function.

The server 10 is connected to the management device 20 via a network N. Although only one network N is illustrated in the example of FIG. 4, there may be a plurality of networks N. Here, the network N is, for example, a public network such as the Internet. Note that the network N is not limited to the Internet, and may be, for example, a local area network (LAN), a wide area network (WAN), a cellular network, a fixed telephone network, or a regional Internet protocol (IP) network. The network N may include a wired network or a wireless network.

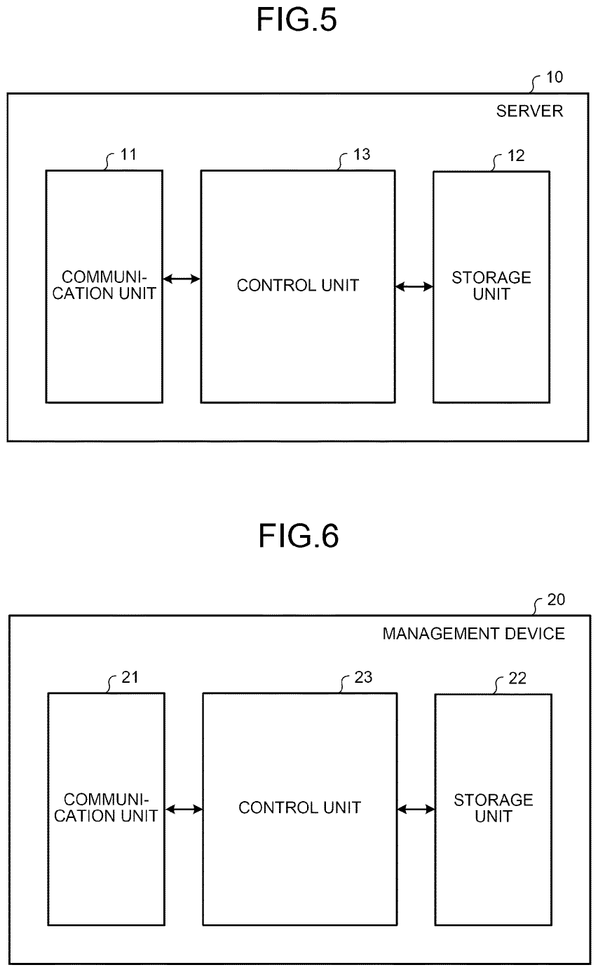

FIG. 5 is a diagram illustrating an example of a configuration of a server 10 according to an embodiment of the present disclosure. The server 10 includes circuitry such as a communication unit 11, a storage unit 12, and a control unit 13. The configuration illustrated in FIG. 5 is a functional configuration, and a hardware configuration may be different from the functional configuration. Furthermore, the functions of the server 10 may be implemented in a distributed manner by a plurality of physically separated components. For example, the server 10 may include a plurality of information processing devices.

The communication unit 11 includes circuitry such as a communication interface for communicating with other devices. For example, the communication unit 11 is a network interface. For example, the communication unit 11 is a local area network (LAN) interface such as a network interface card (NIC). Note that the communication unit 11 may be a wired interface or a wireless interface. The communication unit 11 communicates with the management device 20, the base station 30, the terminal device 40, and another server 10 according to the control of the control unit 13.

The storage unit 12 is a data readable/writable storage device and includes circuitry such as a dynamic random access memory (DRAM), a static random access memory (SRAM), a flash memory, or a hard disk. The storage unit 12 stores a learning model (prediction model) for predicting a future quality of the mobile network. The learning model will be described later.

The control unit 13 is a controller that controls each unit of the server 10. The control unit 13 may be realized by, for example, circuitry such as a processor such as a central processing unit (CPU) or a micro processing unit (MPU). Specifically, the control unit 13 may be realized by the processor executing various programs stored in a storage device inside the management device 20 using a random access memory (RAM) or the like as a work area. The control unit 13 may be realized by an integrated circuit such as an application specific integrated circuit (ASIC) or a field programmable gate array (FPGA). Furthermore, the control unit 13 may be realized by a graphics processing unit (GPU). Any of the CPU, the MPU, the ASIC, the FPGA, and the GPU can be regarded as a controller. Note that the control unit 13 may be constituted by a plurality of physically separated objects. For example, the control unit 13 may be constituted by a plurality of semiconductor chips.

### 2-2. Configuration of Management Device

Next, a configuration of the management device 20 will be described.

The management device 20 is an information processing device (computer) that manages a wireless network. For example, the management device 20 is an information processing device that manages communication of the base station 30. The management device 20 may be, for example, a device having a function as a mobility management entity (MME). The management device 20 may be a device having a function as an access and mobility management function (AMF) and/or a session management function (SMF). The MME, the AMF, and the SMF are control plane network function nodes in a core network. The management device 20 may be a device having a function as a control plane network function (6G CPNF) in 6G. The 6G CPNF may be constituted by one or more logical nodes.

Of course, the functions of the management device 20 are not limited to MME, the AMF, the SMF, and the 6G CPNF. The management device 20 may be a device having a function as a network slice selection function (NSSF), an authentication server function (AUSF), a policy control function (PCF), or a unified data management (UDM). Furthermore, the management device 20 may be a device having a function as a home subscriber server (HSS).

Note that the management device 20 may have a function of a gateway. For example, the management device 20 may have a function as a serving gateway (S-GW) or a packet data network gateway (P-GW). In addition, the management device 20 may have a function of a user plane function (UPF). At this time, the management device 20 may have a plurality of UPFs. Furthermore, the management device 20 may be a device having a function as a user plane network function (6G UPNF) in 6G.

The core network includes a plurality of network functions, and each network function may be aggregated into one physical device or distributed to a plurality of physical devices. That is, the management device 20 can be arranged in a distributed manner in a plurality of devices. Further, this distributed arrangement may be controlled to be performed dynamically. The base station 30 and the management device 20 constitute one network, and provide a wireless communication service to the terminal device 40. The management device 20 is connected to the Internet, and the terminal device 40 can use various services provided through the Internet via the base station 30.

Note that the management device 20 is not necessarily a device constituting the core network. For example, it is assumed that the core network is a core network of wideband code division multiple access (W-CDMA) or code division multiple access 2000 (cdma2000). At this time, the management device 20 may be a device that functions as a radio network controller (RNC).

FIG. 6 is a diagram illustrating a configuration of the management device 20 according to the present embodiment. The management device 20 includes circuitry such as a communication unit 21, a storage unit 22, and a control unit 23. The configuration illustrated in FIG. 6 is a functional configuration, and a hardware configuration may be different from the functional configuration. Furthermore, the functions of the management device 20 may be implemented in a statically or dynamically distributed manner by a plurality of physically separated components. The management device 20 may be constituted by a plurality of server devices.

The communication unit 21 includes circuitry such as a communication interface for communicating with a wireless communication device (e.g., the base station 30). The communication unit 21 may be a network interface or a device connection interface. The communication unit 21 may be a local area network (LAN) interface such as a network interface card (NIC), or a USB interface including a universal serial bus (USB) host controller, a USB port, etc. The communication unit 21 may be a wired interface or a wireless interface. The communication unit 21 is controlled by the control unit 23.

The storage unit 22 is a readable/writable storage device that includes circuitry such as a DRAM, an SRAM, a flash memory, or a hard disk. The storage unit 22 stores, for example, a connection state of the terminal device 40. The storage unit 22 stores a radio resource control (RRC) state and an EPS connection management (ECM) state or a 5G system connection management (CM) state of the terminal device 40. The storage unit 22 may function as a home memory that stores position information of the terminal device 40. In addition, the storage unit 22 stores a learning model (prediction model) for predicting a future quality of the mobile network. The learning model will be described later.

The control unit 23 is a controller that controls each unit of the management device 20. The control unit 23 may be realized by, for example, circuitry such as a processor such as a CPU or an MPU. Specifically, the control unit 23 may be realized by the processor executing various programs stored in a storage device inside the management device 20 using a RAM or the like as a work area. The control unit 23 may be realized by an integrated circuit such as an ASIC or an FPGA. Furthermore, the control unit 23 may be realized by a GPU. Any of the CPU, the MPU, the ASIC, the FPGA, and the GPU can be regarded as a controller. Note that the control unit 23 may be constituted by a plurality of physically separated objects. For example, the control unit 23 may be constituted by a plurality of semiconductor chips.

### 2-3. Configuration of Base Station

Next, a configuration of the base station 30 will be described.

The base station 30 is a wireless communication device that performs wireless communication with other wireless communication devices (e.g., the terminal device 40 and another base station 30). The base station 30 may perform wireless communication with the terminal device 40 via a relay station, or may perform wireless communication with the terminal device 40 in a direct manner.

The base station 30 is a device corresponding to a radio base station (base station, Node B, eNB, gNB, 6GNB, or the like) or a radio access point. The base station 30 may be a wireless relay station. The base station 30 may be an optical extension device called a remote radio head (RRH). The base station 30 may be a receiving station such as a field pickup unit (FPU). The base station 30 may be an integrated access and backhaul (IAB) donor node or an IAB relay node that provides radio access lines and radio backhaul lines in a time division multiplexing manner, in a frequency division multiplexing manner, or in a space division multiplexing manner.

The radio access technology used by the base station 30 may be a cellular communication technology. The radio access technology used by the base station 30 may be a wireless LAN technology. The radio access technology used by the base station 30 may be a low power wide area (LPWA) communication technology. However, the radio access technology used by the base station 30 is not limited thereto, and may be another radio access technology. The wireless communication used by the base station 30 may be wireless communication using millimeter waves or wireless communication using terahertz waves. The wireless communication used by the base station 30 may be wireless communication using radio waves or wireless communication (optical radio) using infrared rays or visible light. Furthermore, the base station 30 may be able to perform non-orthogonal multiple access (NOMA) communication with the terminal device 40. Here, the NOMA communication refers to communication (transmission, reception, or both) using non-orthogonal resources. Note that the base station 30 may be able to perform NOMA communication with another base station 30.

Note that the base station 30 may be able to communicate with the core network via a base station-core network interface (e.g. an NG interface or an S1 Interface). This interface may be either wired or wireless. Furthermore, the base station may be able to communicate with another base station via an inter-base station interface (e.g., an Xn Interface, an X2 Interface, or an F1 Interface). This interface may be either wired or wireless.

The concept of the base station (also referred to as a “base station device”) includes not only a donor base station but also a relay base station (also referred to as a “relay station”). The relay base station may be any one of an RF repeater, a smart repeater, and an intelligent surface. The concept of the base station includes not only a structure having a function of the base station but also a device installed in the structure.

The structure is, for example, a building such as a high-rise building, a house, a steel tower, a station facility, an airport facility, a harbor facility, an office building, a school building, a hospital, a factory, a commercial facility, or a stadium. The concept of the structure includes not only a building but also a construction (non-building structure) such as a tunnel, a bridge, a dam, a wall, or an iron pillar, and equipment such as a crane, a gate, or a windmill. The concept of the structure includes not only a structure on land (on the ground in a narrow sense) or under ground, but also a structure on water such as a pier or a megafloat, and a structure under water such as an ocean observation facility. The base station may also be referred to as an information processing device.

The base station 30 may be a donor station or a relay station. Furthermore, the base station 30 may be a fixed station or a mobile station. The mobile station is a wireless communication device (e.g. a base station) configured to be movable. At this time, the base station 30 may be a device installed in a mobile object or may be a mobile object itself. For example, the relay station having mobility can be considered to be a base station 30 as a mobile station. In addition, a device that originally has mobility and has functions of a base station (at least some of the functions of the base station), such as a vehicle, an unmanned aerial vehicle (UAV) represented by a drone, or a smartphone, also corresponds to a base station 30 as a mobile station.

Here, the mobile object may be a mobile terminal such as a smartphone or a mobile phone. The mobile object may be a mobile object (e.g., a vehicle such as an automobile, a bicycle, a bus, a truck, a motorcycle, a train, or a linear motor car) that moves on land (on the ground in a narrow sense), or may be a mobile object (e.g., a subway) that moves under ground (for example, in a tunnel). In addition, the mobile object may be a mobile object (e.g., a ship such as a passenger ship, a cargo ship, or a hovercraft) that moves on water, or may be a mobile object (e.g., a submarine ship such as a submersible, a submarine, or an unmanned submarine) that moves under water. Furthermore, the mobile object may be a mobile object (e.g., an aircraft such as an airplane, an airship, or a drone) that moves in the atmosphere.

The base station 30 may be a ground base station (ground station) installed on the ground. The base station 30 may be a base station arranged in a structure on the ground or may be a base station installed in a mobile object moving on the ground. The base station 30 may be an antenna installed in a structure such as a building and a signal processing device connected to the antenna. The base station 30 may be a structure or a mobile object itself. The term “ground” means not only on land (on the ground in a narrow sense) but also on the ground in a broad sense including under ground, on water, and under water. The base station 30 is not limited to a ground base station. In a case where the communication system 1 is a satellite communication system, the base station 30 may be an aircraft station. From the perspective of a satellite station, an aircraft station located on the earth is a ground station.

The base station 30 is not limited to a ground station. The base station 30 may be a non-ground base station device (non-ground station) capable of floating in the air or space. The base station 30 may be an aircraft station or a satellite station.

The satellite station is a satellite station capable of floating outside the atmosphere. The satellite station may be a device mounted on a space mobile object such as an artificial satellite, or may be a space mobile object itself. The space mobile object is a mobile object that moves outside the atmosphere. The space mobile object may be an artificial celestial object such as an artificial satellite, a spacecraft, a space station, or a probe. Note that the satellite serving as a satellite station may be any one of a low earth orbiting (LEO) satellite, a medium earth orbiting (MEO) satellite, a geostationary earth orbiting (GEO) satellite, and a highly elliptical orbiting (HEO) satellite. The satellite station may be a device mounted on a low earth orbiting satellite, a medium earth orbiting satellite, a geostationary earth orbiting satellite, or a highly elliptical orbiting satellite.

The aircraft station is a wireless communication device capable of floating in the atmosphere, such as an aircraft. The aircraft station may be a device mounted on an aircraft or the like, or may be an aircraft itself. The concept of the aircraft includes not only a heavy aircraft, such as an airplane or a glider, but also a light aircraft, such as a balloon or an airship. The concept of the aircraft includes a rotorcraft such as a helicopter and an autogyro as well as the heavy aircraft or the light aircraft. The aircraft station or the aircraft on which the aircraft station is mounted may be an unmanned aerial vehicle such as a drone.

The concept of the unmanned aerial vehicle also includes an unmanned aircraft system (UAS) or a tethered UAS. The concept of the unmanned aerial vehicle also includes a lighter than air (LTA) UAS and a heavier than air (HTA) UAS. The concept of the unmanned aerial vehicle also includes a high altitude UAS platform (HAP).

The coverage size of the base station 30 may be relatively large such as a macro cell or may be relatively small such as a pico cell. The coverage size of the base station 30 may be extremely small, such as a femtocell. The base station 30 may have a beamforming function. The base station 30 may form a cell or a service area for each beam. Additionally or alternatively, the base station 30 may have a function of delivering a desired wave to a predetermined point as a pinpoint, by further considering information on a distance from an antenna of the base station 30, in addition to beamforming for giving directivity to a beam. This function may be called beam focusing or point forming.

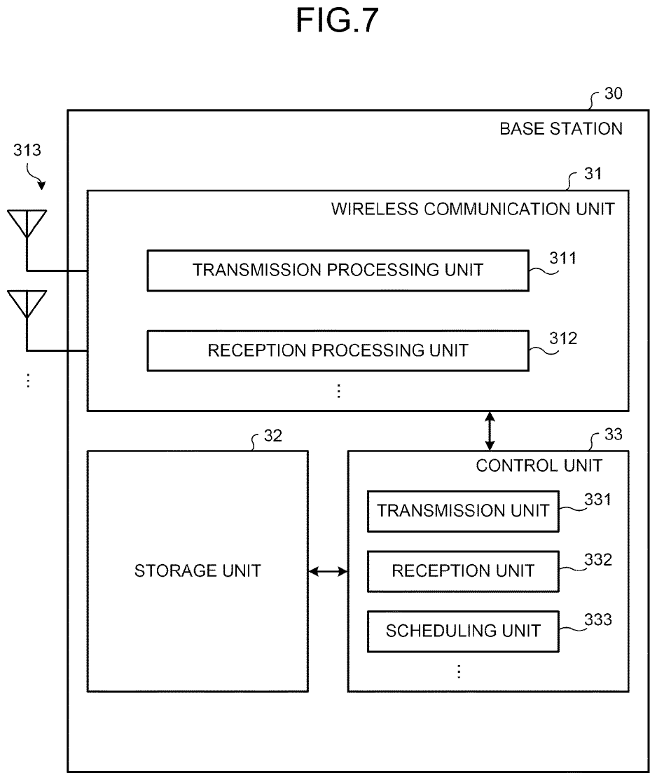

FIG. 7 is a diagram illustrating a configuration of the base station 30 according to the present embodiment. The base station 30 includes circuitry such as a wireless communication unit 31, a storage unit 32, and a control unit 33. However, the configuration illustrated in FIG. 7 is a functional configuration, and a hardware configuration may be different from the functional configuration. Furthermore, the functions of the base station 30 may be implemented in a distributed manner by a plurality of physically separated configurations.

The wireless communication unit 31 is a signal processing unit for wirelessly communicating with other wireless communication devices (e.g., the terminal device 40 and another base station 30). The wireless communication unit 31 is controlled by the control unit 33. The wireless communication unit 31 corresponds to one or more radio access schemes. The wireless communication unit 31 may correspond to at least one of NR, LTE, and 6G. The wireless communication unit 31 may correspond to W-CDMA, cdma2000, and the like in addition to NR, LTE, and 6G. The wireless communication unit 31 may correspond to an automatic retransmission technology such as hybrid automatic repeat request (HARQ).

The wireless communication unit 31 includes circuitry such as a transmission processing unit 311, a reception processing unit 312, and an antenna 313. The wireless communication unit 31 may include a plurality of transmission processing units 311, a plurality of reception processing units 312, and a plurality of antennas 313. In a case where the wireless communication unit 31 corresponds to a plurality of radio access schemes, each unit of the wireless communication unit 31 may be configured individually for each radio access scheme. The transmission processing units 311 and the reception processing units 312 may be individually configured for LTE, NR, and 6G. The antenna 313 may be constituted by a plurality of antenna elements, e.g., a plurality of patch antennas. The wireless communication unit 31 may have a beamforming function. For example, the wireless communication unit 31 may have a polarization beamforming function using vertically polarized waves (V-polarized waves) and horizontally polarized waves (H-polarized waves) (or a polarization beamforming function using dual-polarized waves in polarization directions of 45 degrees and −45 degrees from the vertical direction).

The transmission processing unit 311 transmits downlink control information and downlink data. For example, the transmission processing unit 311 includes circuitry that encodes the downlink control information and the downlink data input from the control unit 33 using an encoding method such as block encoding, convolutional encoding, or turbo encoding. Here, the encoding may be performed using a polar code or a low density parity check code (LDPC code). Then, the transmission processing unit 311 modulates coded bits using a predetermined modulation method such as binary phase shift keying (BPSK), quadrature phase shift keying (QPSK), or quadrature amplitude modulation (16QAM, 64QAM, or 356QAM). In this case, signal points on the constellation do not need to be equidistant. The constellation may be a non-uniform constellation (NUC). Then, the transmission processing unit 311 multiplexes a modulation symbol of each channel and a downlink reference signal and arranges them in predetermined resource elements. Then, the transmission processing unit 311 performs various types of signal processing on the multiplexed signal. For example, the transmission processing unit 311 performs processing such as conversion into a frequency domain by fast Fourier transform, addition of a guard interval (cyclic prefix), generation of a baseband digital signal, conversion into an analog signal, quadrature modulation, up-conversion, removal of an extra frequency component, and amplification of power. The signal generated by the transmission processing unit 311 is transmitted from the antenna 313.

The reception processing unit 312 processes the uplink signal received via the antenna 313. For example, the reception processing unit 312 includes circuitry that performs down-conversion, removal of an unnecessary frequency component, control of an amplification level, quadrature demodulation, conversion to a digital signal, removal of a guard interval (cyclic prefix), extraction of a frequency domain signal by fast Fourier transform, and the like on the uplink signal. Then, the reception processing unit 312 separates an uplink channel such as a physical uplink shared channel (PUSCH) or a physical uplink control channel (PUCCH) and an uplink reference signal from the signal subjected to such processing. Further, the reception processing unit 312 demodulates the received signal using a modulation scheme such as binary phase shift keying (BPSK) or quadrature phase shift keying (QPSK) with respect to a modulation symbol of the uplink channel. The modulation scheme used for demodulation may be 16 quadrature amplitude modulation (QAM), 64QAM, or 356QAM. In this case, signal points on the constellation do not need to be equidistant. The constellation may be a non-uniform constellation (NUC). Then, the reception processing unit 312 performs decoding processing on encoded bits of the demodulated uplink channel. The decoded uplink data and uplink control information are output to the control unit 33.

The antenna 313 is an antenna device that converts a current into a radio wave and converts a radio wave into a current. The antenna 313 may be constituted by one antenna element, e.g., one patch antenna. The antenna 313 may also be constituted by a plurality of antenna elements, e.g., a plurality of patch antennas. In a case where the antenna 313 are constituted by a plurality of antenna elements, the wireless communication unit 31 may have a beamforming function. The wireless communication unit 31 may be configured to generate a directional beam by controlling a directivity of a wireless signal using the plurality of antenna elements. The antenna 313 may be a dual-polarized antenna. In a case where the antenna 313 is a dual-polarized antenna, the wireless communication unit 31 may use vertically polarized waves (V-polarized waves) and horizontally polarized waves (H-polarized waves) (or dual-polarized waves in polarization directions of 45 degrees and −45 degrees from the vertical direction) at the time of transmitting a wireless signal. The wireless communication unit 31 may control a directivity of the wireless signal transmitted using vertically polarized waves and horizontally polarized waves (or dual-polarized waves in polarization directions of 45 degrees and −45 degrees from the vertical direction). Furthermore, the wireless communication unit 31 may transmit and receive spatially multiplexed signals via a plurality of layers constituted by a plurality of antenna elements.

The storage unit 32 includes circuitry such as a readable/writable storage device such as a DRAM, an SRAM, a flash memory, or a hard disk.

The control unit 33 is a controller that controls each unit of the base station 30. The control unit 33 controls the wireless communication unit to perform wireless communication with another wireless communication device (e.g., the terminal device 40 or another base station 30). The control unit 33 may be realized by circuitry such as a processor such as a CPU or an MPU. Specifically, the control unit 33 may be implemented by the processor executing various programs stored in a storage device inside the base station 30 using a RAM or the like as a work area. The control unit 33 may be realized by an integrated circuit such as an ASIC or an FPGA. Furthermore, the control unit 33 may be realized by a GPU. Any of the CPU, the MPU, the ASIC, the FPGA, and the GPU can be regarded as a controller. Note that the control unit 33 may be constituted by a plurality of physically separated objects. For example, the control unit 33 may be constituted by a plurality of semiconductor chips.

The control unit 33 includes circuitry such as a transmission unit 331, a reception unit 332, and a scheduling unit 333. Each of the blocks (the transmission unit 331 to the scheduling unit 333) constituting the control unit 33 is a functional block indicating a corresponding one of the functions of the control unit 33. These functional blocks may be software blocks executed by hardware circuitry or hardware blocks. For example, each of the above-described functional blocks may be one software module realized by software (including a microprogram), or may be one circuit block on a semiconductor chip (die). Of course, each of the functional blocks may be one processor or one integrated circuit. The control unit 33 may be configured by functional units different from the above-described functional blocks. Any method may be used in configuring the functional blocks.

Note that, in some embodiments, the base station 30 may be constituted by a set of a plurality of physical or logical devices. As an example, the base station 30 according to the present embodiment may be divided into a plurality of devices such as a baseband unit (BBU) and a radio unit (RU). The base station 30 may be interpreted as a set of the plurality of devices. In addition, the base station may be a BBU, an RU, or both. The BBU and the RU may be connected to each other by a predetermined interface, e.g., an enhanced common public radio interface (eCPRI).

The RU may be referred to as a remote radio unit (RRU) or a radio dot (RD). The RU may correspond to a gNB distributed unit (gNB-DU) to be described later. The BBU may correspond to a gNB central unit (gNB-CU) to be described later. The RU may be a device integrally formed with the antenna. The antenna of the base station 30, e.g., the antenna integrally formed with the RU, may adopt an advanced antenna system and support MIMO such as FD-MIMO or beamforming. The antenna of the base station 30 may include, for example, 64 transmission antenna ports and 64 reception antenna ports.

The antenna mounted on the RU may be an antenna panel constituted by one or more antenna elements, and one or more antenna panels may be mounted on the RU. Two types of antenna panels, that is, a horizontally polarized antenna panel and a vertically polarized antenna panel, may be mounted on the RU. Two types of antenna panels, that is, a right-handed circularly polarized antenna panel and a left-handed circularly polarized antenna panel, may be mounted on the RU, or an antenna panel with a polarization direction of 45 degrees from the vertical direction and an antenna panel with a polarization direction of −45 degrees from the vertical direction may be mounted on the RU. The plurality of antennas having a plurality of polarization directions may be mounted on one antenna panel. The RU may be controlled by forming an independent beam for each antenna panel.

A plurality of base stations 30 may be connected to each other. The one or more base stations 30 may be included in a radio access network (RAN). At this time, the base station 30 may be simply referred to as a RAN, a RAN node, an access network (AN), an AN node, or the like. The RAN in LTE may be referred to as an enhanced universal terrestrial RAN (EUTRAN). The RAN in NR may be referred to as NGRAN. In addition, the RAN in 6G may be referred to as 6GRAN. The RAN in W-CDMA (UMTS) may be referred to as UTRAN.

The base station 30 in LTE may be referred to as an evolved node B (eNodeB) or an eNB. At this time, the EUTRAN includes one or more eNodeBs (eNBs). The base station 30 in NR may be referred to as a gNodeB or a gNB. At this time, the NGRAN includes one or more gNBs. The base station in 6G may be referred to as a 6GNodeB, a 6gNodeB, a 6GNB, or a 6gNB. At this time, the 6GRAN includes one or more 6GNBs. The EUTRAN may include a gNB (en-gNB) connected to a core network (EPC) in an LTE communication system (EPS). The NGRAN may include an ng-eNB connected to a core network 5GC in a 5G communication system (5GS).

In a case where the base station 30 is an eNB, a gNB, a 6GNB, or the like, the base station 30 may be referred to as a 3GPP access. In a case where the base station 30 is a radio access point, the base station 30 may be referred to as a non-3GPP access. The base station 30 may be an optical extension device called a remote radio head (RRH). In a case where the base station 30 is a gNB, the base station 30 may be a combination of the gNB-CU and the gNB-DU described above, or may be either the gNB-CU or the gNB-DU.

Here, the gNB-CU hosts a plurality of upper layers (e.g., radio resource control (RRC), service data adaptation protocol (SDAP), and packet data convergence protocol (PDCP)) among access strata for communication with the UE. On the other hand, the gNB-DU hosts a plurality of lower layers (e.g., radio link control (RLC), medium access control (MAC), and physical layer (PHY)) among access strata. That is, among messages/information to be described later, RRC signaling (quasi-static notification) may be generated by the gNB-CU, while MAC CE and DCI (dynamic notification) may be generated by the gNB-DU. Alternatively, among RRC configurations (quasi-static notifications), some configurations such as IE: cellGroupConfig may be generated by the gNB-DU, and the other configurations may be generated by the gNB-CU. These configurations may be transmitted and received through an F1 interface described later.

The base station 30 may be configured to be able to communicate with other base stations. In a case where the plurality of base stations 30 are eNBs or a combination of eNBs and an en-gNBs, these base stations 30 may be connected to each other by an X2 interface. In a case where the plurality of base stations 30 are gNBs or a combination of gn-eNBs and gNBs, these base stations 30 may be connected to each other by an Xn interface. In a case where the plurality of base stations 30 are a combination of gNB-CUs and gNB-DUs, these base stations 30 may be connected to each other by the above-described F1 interface. The message/information (e.g., RRC signaling, MAC control element (MAC CE), downlink control information (DCI), or the like.) to be described later may be transmitted between the plurality of base stations 30 via, for example, the X2 interface, the Xn interface, the F1 interface, or the like.

Cells provided by the base station 30 may be referred to as serving cells. The concept of the serving cells includes primary cells (PCells) and secondary cells (SCells). In a case where dual connectivity is provided to the terminal device 40, PCells provided by a master node (MN) and 0 or one or more SCells may be referred to as a master cell group. Examples of the dual connectivity include EUTRA-EUTRA dual connectivity, EUTRA-NR dual connectivity (ENDC), EUTRA-NR dual connectivity with 5GC, NR-EUTRA dual connectivity (NEDC), and NR-NR dual connectivity. Further, examples of the dual connectivity include NR-6G dual connectivity and 6G-NR dual connectivity.

The serving cells may include PSCells (primary secondary cells or primary SCG cells). In a case where dual connectivity is provided to the terminal device 40, PSCells provided by a secondary node (SN) and 0 or 1 or more SCells may be referred to as a secondary cell group (SCG). Unless specifically configured (for example, PUCCH on SCell), the physical uplink control channel (PUCCH) is transmitted by the PCell and the PSCell, but is not transmitted by the SCell. A radio link failure is detected by the PCell and the PSCell, but is not detected (may not be detected) by the SCell. As described above, since the PCell and the PSCell play a special role among the serving cells, they are also referred to as special cells (SpCells).

One downlink component carrier and one uplink component carrier may be associated with one cell. A system bandwidth corresponding to one cell may be divided into a plurality of bandwidth parts (BWPs). At this time, one or more BWPs may be set in the terminal device 40, and one BWP may be used as an active BWP in the terminal device 40. A radio resource that can be used by the terminal device 40, for example, frequency band, numerology (subcarrier spacing), or slot format (slot configuration), may be different for each cell, each component carrier, or each BWP.

### 2-4. Configuration of Terminal Device

Next, a configuration of the terminal device 40 will be described.

The terminal device 40 is a wireless communication device that performs wireless communication with another wireless communication device (e.g., the base station 30 or another terminal device 40). As the terminal device 40, any form of information processing device (computer) can be employed. For example, the terminal device 40 may be a mobile terminal such as a mobile phone, a smart device (a smartphone or a tablet), a personal digital assistant (PDA), or a notebook PC. Furthermore, the terminal device 40 may be an imaging device (e.g., a camcorder) having a communication function. Furthermore, the terminal device 40 may be a motorcycle, a moving relay vehicle, or the like on which a communication device such as a field pickup unit (FPU) is mounted. Furthermore, the terminal device 40 may be a machine to machine (M2M) device or an Internet of Things (IoT) device. Furthermore, the terminal device 40 may be a wearable device such as a smart watch.

Furthermore, the terminal device 40 may be an xR device such as an augmented reality (AR) device, a virtual reality (VR) device, or a mixed reality (MR) device. At this time, the xR device may be a glasses-type device such as AR glasses or MR glasses, or may be a head-mounted device such as a VR head-mounted display. In a case where the terminal device 40 is an xR device, the terminal device 40 may be a stand-alone device consisting only of a user-worn part (e.g., a glasses part). Furthermore, the terminal device 40 may be a terminal-linked device including a user-worn part (e.g., a glasses part) and a terminal part (e.g., a smart device) that operates in conjunction with the user-worn part.

The terminal device 40 may be able to perform NOMA communication with the base station 30. The terminal device 40 may be able to use an automatic retransmission technology such as HARQ when communicating with the base station 30. The terminal device 40 may be able to perform sidelink communication with another terminal device 40. The terminal device 40 may be able to use an automatic retransmission technology such as HARQ when performing sidelink communication. The terminal device 40 may be able to perform NOMA communication when performing sidelink communication with another terminal device 40. The terminal device 40 may be able to perform LPWA communication with another other wireless communication device such as the base station 30. The wireless communication used by the terminal device 40 may be wireless communication using millimeter waves. The wireless communication used by the terminal device 40 may be wireless communication using radio waves, including sidelink communication, or may be wireless communication using infrared rays or visible light, that is, optical radio.

The terminal device 40 may be a movable wireless communication device, that is, a mobile device. The terminal device 40 may be a wireless communication device installed in a mobile object or may be a mobile object itself. The terminal device 40 may be a vehicle that moves on a road, such as an automobile, a bus, a truck, or a motorcycle, or may be a wireless communication device mounted on the vehicle. The mobile object may be a mobile terminal, or may be a mobile object that moves on land (on the ground in a narrow sense), under ground, on water, or under water. Furthermore, the mobile object may be a mobile object that moves inside the atmosphere, such as an aircraft, an airship, a balloon, or a helicopter, or may be a mobile object that moves outside the atmosphere, such as an artificial satellite. The mobile object may be an unmanned aerial vehicle (UAV) such as a drone. Furthermore, the terminal device 40 may be a wireless communication device mounted on a mobile object.

The terminal device 40 may be able to be connected to a plurality of base stations 30 or a plurality of cells at the same time for communication. In a case where one base station 30 supports a communication area via a plurality of cells (e.g., pCells or sCells), the plurality of cells can be bundled by a carrier aggregation (CA) technology, a dual connectivity (DC) technology, a multi-connectivity (MC) technology, or the like for communication between the base station 30 and the terminal device 40. Alternatively, through cells of different base stations 30, the terminal device 40 and the plurality of base stations 30 may communicate with each other by a coordinated multi-point transmission and reception (CoMP) technology.

The terminal device 40 may be a relay terminal that relays communication to a remote terminal.

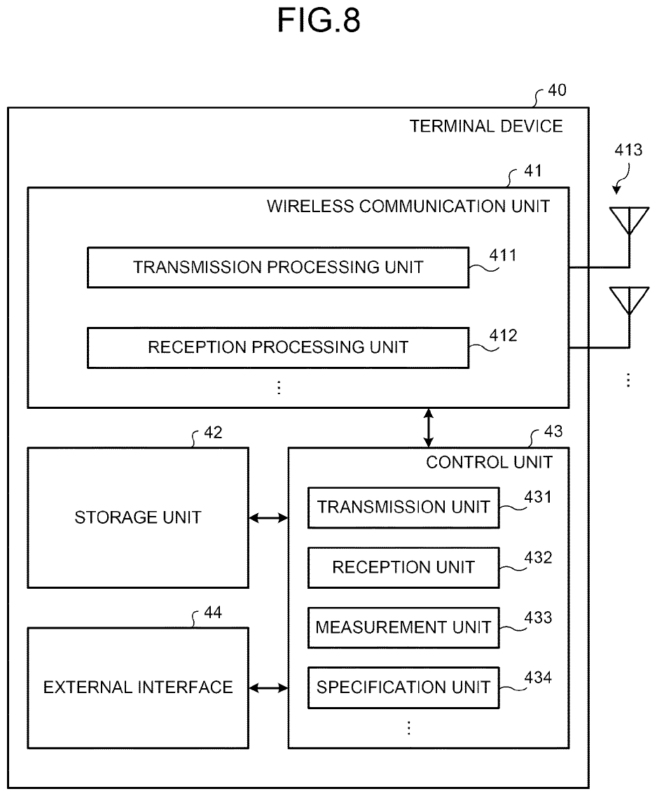

FIG. 8 is a diagram illustrating a configuration of the terminal device 40 according to the present embodiment. The terminal device 40 includes circuitry such as a wireless communication unit 41, a storage unit 42, a control unit 43, and an external interface 44. The configuration illustrated in FIG. 8 is a functional configuration, and a hardware configuration may be different from the functional configuration. Furthermore, the functions of the terminal device 40 may be implemented in a distributed manner by a plurality of physically separated configurations.

The wireless communication unit 41 is a signal processing unit for wirelessly communicating with other wireless communication devices (e.g., the base station 30 or another terminal device 40). The wireless communication unit 41 is controlled by the control unit 43. The wireless communication unit 41 corresponds to one or more radio access schemes. The wireless communication unit 41 may correspond to at least one of NR, LTE, and 6G. The wireless communication unit 41 may correspond to W-CDMA, cdma2000, and the like in addition to NR, LTE, and 6G. The wireless communication unit 41 may correspond to an automatic retransmission technology such as hybrid automatic repeat request (HARQ).

The wireless communication unit 41 includes circuitry such as a transmission processing unit 411, a reception processing unit 412, and an antenna 413. The wireless communication unit 41 may include a plurality of transmission processing units 411, a plurality of reception processing units 412, and a plurality of antennas 413. When the wireless communication unit 41 corresponds to a plurality of radio access schemes, each unit of the wireless communication unit 41 may be configured individually for each radio access scheme. The transmission processing units 411 and the reception processing units 412 may be individually configured for LTE, NR, and 6G. The antenna 413 may be constituted by a plurality of antenna elements, e.g., a plurality of patch antennas. The wireless communication unit 41 may have a beamforming function. For example, the wireless communication unit 41 may have a polarization beamforming function using vertically polarized waves (V-polarized waves) and horizontally polarized waves (H-polarized waves) (or a polarization beamforming function using dual-polarized waves in polarization directions of 45 degrees and −45 degrees from the vertical direction).

The storage unit 42 includes circuitry such as a readable/writable storage device such as a DRAM, an SRAM, a flash memory, or a hard disk.

The control unit 43 is a controller that controls each unit of the terminal device 40. The control unit 43 controls the wireless communication unit to perform wireless communication with another wireless communication device (e.g., the base station 30 or another terminal device 40). The control unit 43 may be realized by circuitry such as a processor such as a CPU or an MPU. Specifically, the control unit 43 may be realized by the processor executing various programs stored in a storage device inside the terminal device 40 using a RAM or the like as a work area. The control unit 43 may be realized by an integrated circuit such as an ASIC or an FPGA. Any of the CPU, the MPU, the ASIC, and the FPGA can be regarded as a controller. The control unit 43 may be realized by a GPU. Any of the CPU, the MPU, the ASIC, the FPGA, and the GPU can be regarded as a controller. Note that the control unit 43 may be constituted by a plurality of physically separated objects. For example, the control unit 43 may be constituted by a plurality of semiconductor chips.

The control unit 43 includes circuitry such as a transmission unit 431, a reception unit 432, a measurement unit 433, and a specification unit 434. Each of the blocks (the transmission unit 431 to the specification unit 434) constituting the control unit 43 is a functional block indicating a corresponding one of the functions of the control unit 43. These functional blocks may be software blocks or hardware blocks. For example, each of the above-described functional blocks may be one software module realized by software (including a microprogram), or may be one circuit block on a semiconductor chip (die). Of course, each of the functional blocks may be one processor or one integrated circuit. The control unit 43 may be configured by functional units different from the above-described functional blocks. Any method may be used in configuring the functional blocks.

The external interface 44 includes circuitry such as a communication interface for connecting the terminal device 40 to another terminal device (external device). The external interface 44 may be a wired interface such as a universal serial bus (USB) or a wired LAN, or may be a wireless interface such as a wireless LAN or Bluetooth.

The configuration of the communication system 1 has been described above. Next, an operation of the communication system 1 according to the present embodiment will be described.

### 3. First Embodiment

First, an operation of a communication system 1 according to a first embodiment will be described.

### 3-1. Example of Functional Configuration

First, an example of a functional configuration of a communication device according to the first embodiment will be described. The communication device (terminal device 40) according to the first embodiment can be configured as follows.

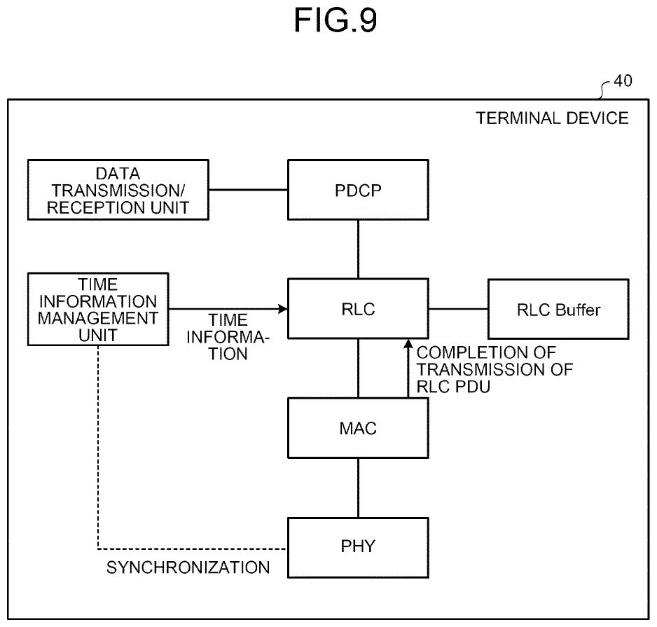

FIG. 9 is a functional block diagram of the terminal device 40 according to the first embodiment. The terminal device 40 includes a block that performs processing on a packet data convergence protocol (PDCP) layer (PDCP illustrated in FIG. 9), a block that performs processing on a radio link control (RLC) layer (RLC illustrated in FIG. 9), a block that performs processing on a medium access control (MAC) layer (MAC illustrated in FIG. 9), and a block that performs processing on a physical layer (PHY illustrated in FIG. 9). These blocks can be realized by, for example, the wireless communication unit 41 and the control unit 43 illustrated in FIG. 8. In addition, the terminal device 40 includes an RLC buffer. This block can be realized by, for example, the storage unit 42 illustrated in FIG. 8.

Furthermore, the terminal device 40 includes a data transmission/reception unit. This block can be realized by, for example, the transmission unit 431 and the reception unit 432 illustrated in FIG. 8. Furthermore, the terminal device 40 includes a time information management unit. This block can be realized by, for example, the measurement unit 433 and the storage unit 42 illustrated in FIG. 8. The time information management unit notifies the RLC of time information. The time information managed by the time information management unit may be, for example, a frame number, a self-running clock managed by a processor, or the like. In a case where the time information is a frame number, the time information management unit may synchronize the frame number with the PHY.

### 3-2. Details of Operation

Next, an operation of the communication device (terminal device 40) according to the first embodiment will be described.

In the first embodiment, the terminal device 40 measures residence times of one or more packets to be transmitted to another communication device for the respective packets. For example, the terminal device 40 measures residence times of one or more uplink packets to be transmitted to the base station 30 for the respective packets. Then, the terminal device 40 transmits residence time information including information regarding the residence times to the base station 30. The base station 30 performs scheduling for uplink communication based on the received residence time information. The operation of the communication system 1 (the base station 30 and the terminal device 40) can be more specifically described as the following means 1-1 to 1-3. Note that the packet described above or below may be an aggregate of data (e.g., a bit string or a bit sequence) that can be processed or transmitted per unit time. For example, the packet described above or below may be a protocol data unit (PDU) or a service data unit (SDU) in a certain layer (e. g., PDCP, RLC, MAC, or PHY). The PDU is an aggregate of data (e.g., a bit string) to which a header is added to an SDU in a certain layer. When the PDU is passed to the lower layer, the PDU becomes an SDU of the lower layer. The SDU corresponds to a PDU provided from a layer upper than a certain layer, and is an aggregate of data (e.g., a bit string) to be processed in the certain layer. Additionally or alternatively, the packet described above or below may be referred to as a segment or a frame.

### (1) Means 1-1 (Average Residence Time)

The terminal device 40 measures residence times of one or more uplink packets to be transmitted to the base station 30 for the respective packets, and specifies an average value (hereinafter, also referred to as an average residence time) of the residence times based on the measurement values for the respective packets. At this time, the RLC of the terminal device 40 may calculate residence times of remaining PDUs at a timing when the MAC notifies completion of transmission of RLC PDU, and hold an average value of the calculated residence times in the buffer. Note that the terminal device 40 may specify an average residence time for each logical channel group (LCG) (alternatively, each logical channel). Since information is stored for each LCG in the BSR, in a case where priorities of logical channels mapped to the same LCG are different, a value of a logical channel to which the highest priority is set may be prioritized. The average residence time (the average value of residence times) may be a moving average value.

It is assumed that the average value is related to a cycle in which resources are allocated to the terminal (LCG). The terminal device 40 transmits residence time information including the average residence time to the base station 30. At this time, the terminal device 40 may incorporate the residence time information in the BSR and transmit the BSR to the base station. For example, the terminal device 40 acquires an average value of residence times at a timing when the transmission of the BSR is triggered. Then, the terminal device 40 incorporates residence time information including information regarding the average value in the BSR and transmits the BSR to the base station 30. In a case where the residence time information is incorporated in the BSR, a new area for storing the residence time information may be provided in the BSR. The base station 30 extracts the residence time information from the received BSR. Then, the base station 30 performs scheduling for uplink communication based on the residence time information (e.g., the information on the average residence time).

### (2) Means 1-2 (Maximum Residence Time)

The average residence time of means 1-1 is calculated based on past measurement values. Therefore, it is assumed that means 1-1 is vulnerable to an instantaneous delay variation (jitter). Therefore, the terminal device 40 may transmit information regarding a maximum value of the residence times (hereinafter, also referred to as a maximum residence time) to the base station 30.

For example, the terminal device 40 measures residence times of one or more uplink packets to be transmitted to the base station 30 for the respective packets, and specifies a maximum value of the residence times (a maximum residence time) based on the measurement values for the respective packets. At this time, the RLC of the terminal device 40 may calculate residence times of remaining PDUs at a timing when the MAC notifies completion of transmission of RLC PDU, and hold a maximum value of the calculated residence times in the buffer. Note that the terminal device 40 may specify a maximum residence time for each LCG (alternatively, for each logical channel). The terminal device 40 specifies a maximum residence time among residence times of a plurality of RLC PDUs held in the LCG. Note that, since information is stored for each LCG in the BSR, in a case where priorities of logical channels mapped to the same LCG are different, a value of a logical channel to which the highest priority is set may be prioritized.

The terminal device 40 transmits residence time information including the maximum residence time to the base station 30. At this time, the terminal device 40 may incorporate the residence time information in the BSR and transmit the BSR to the base station. For example, the terminal device 40 acquires a maximum value of residence times at a timing when the transmission of the BSR is triggered, and incorporates residence time information including information regarding the maximum value in the BSR and transmits the BSR to the base station 30. Note that the terminal device 40 may transmit the residence time information to the base station 30 each time an uplink packet is transmitted to the base station. For example, in order to update residence time information each time an MAC PDU is transmitted to the base station 30, the terminal device 40 may place, on the PUSCH, a BSR including a maximum residence time at a timing when the MAC PDU is transmitted. In a case where the residence time information is incorporated in the BSR, a new area for storing the residence time information may be provided in the BSR. The base station 30 extracts the residence time information from the received BSR. Then, the base station 30 performs scheduling for uplink communication based on the residence time information (e.g., the information on the maximum residence time).

### (3) Means 1-3 (Hybrid of Means 1-1 And Means 1-2)

It is assumed that a plurality of RLC PDUs are held in the LCG. Therefore, if the terminal device 40 notifies the base station 30 of the longest residence time among the residence times of the plurality of RLC PDUs held in the LCG, the longest residence time may be applied to other RLC PDUs when the base station 30 performs scheduling. This problem can be avoided if the terminal device 40 transmits, to the base station, information on the average residence time in addition to information on the maximum residence time.

For example, the terminal device 40 specifies an average value of the residence times in addition to the maximum value of the residence times. Then, the terminal device 40 transmits, to the base station 30, residence time information including at least information regarding the maximum value of the residence times and information regarding the average value of the residence times. At this time, the terminal device 40 incorporates information regarding a maximum residence time in a BSR when transmitting a first PDU, and incorporates information regarding an average residence time in a BSR when transmitting another PDU. As an example of application, the terminal device 40 may notify residence times related to N PDUs. If a packet arrival frequency is known by the service, the management device 20, the base station 30, or the terminal device 40 may define a value of N based on a BSR notification frequency.

### (4) Other Means

In means 1-1 to 1-3, the terminal device 40 specifies an average value (an average residence time) and/or a maximum value (a maximum residence time) based on measurement values for the respective packets. That is, in means 1-1 to 1-3, a current or past value of a residence time of a packet is specified. However, the terminal device 40 may specify a future value (a predicted value) of a residence time of a packet. For example, the terminal device 40 specifies a predicted value of a residence time (hereinafter referred to as a predicted residence time) in addition to the average value and/or the maximum value of the residence times. At this time, the terminal device 40 may predict a future residence time using artificial intelligence (AI)/machine learning (ML). For example, the terminal device 40 may predict the future residence time by inputting measurement values for the respective packets to a learning model learned in advance using past data. Note that the terminal device 40 may specify a predicted residence time for each LCG (alternatively, for each logical channel).

Then, the terminal device 40 transmits residence time information including information regarding the predicted residence time to the base station 30. The residence time information may include information regarding the maximum residence time and/or the maximum residence time described above. At this time, the terminal device 40 may incorporate the residence time information in the BSR and transmit the BSR to the base station. For example, the terminal device 40 acquires a predicted value of a residence time at a timing when the transmission of the BSR is triggered, and incorporates residence time information including information regarding the predicted value in the BSR and transmits the BSR to the base station 30. Note that the terminal device 40 may transmit the residence time information to the base station 30 each time an uplink packet is transmitted to the base station. The base station 30 extracts the residence time information from the received BSR. Then, the base station 30 performs scheduling for uplink communication based on the residence time information (e.g., the information on the maximum residence time and the predicted residence time).

The residence time is not limited to the above-described time (a maximum residence time, an average residence time, a predicted residence time, and a combination thereof), and may be, for example, a representative value (e.g., a maximum value or the like in a predetermined period of time).

### 3-3. Example of Format of BSR

As described above, the terminal device 40 transmits a buffer status report (BSR) including residence time information to the base station 30. At this time, a new area for storing the residence time information may be provided in the BSR.

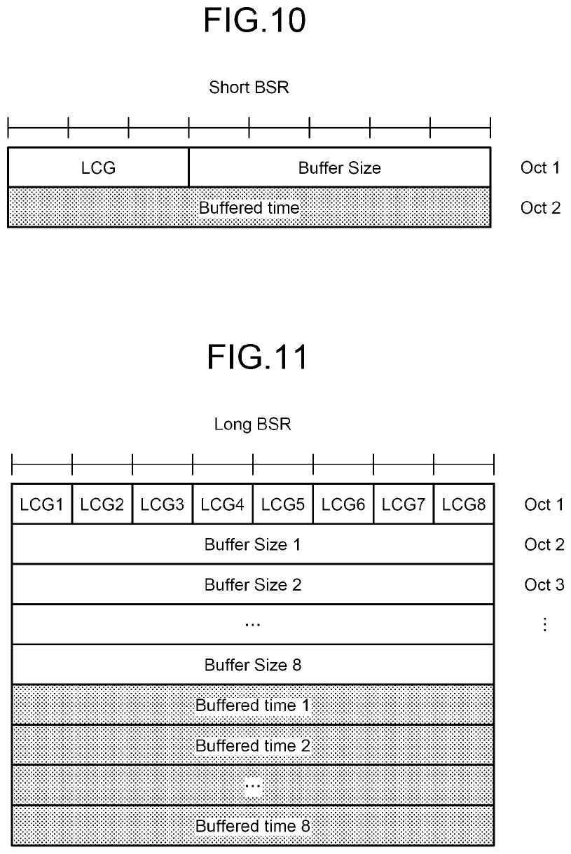

FIGS. 10 and 11 are diagrams each illustrating an example of a format of a BSR in which residence time information can be stored. Specifically, each of FIGS. 10 and 11 illustrates an example in which a new area for storing residence time information is provided in a format of a BSR MAC control element (CE) defined in 3 GPP TS 38.321 for NR. FIG. 10 illustrates an example of a short BSR, and FIG. 11 illustrates an example of a long BSR. In the examples of FIGS. 10 and 11, a 1-octet area (a buffered time area) for notifying residence times is newly provided for each logical channel group ID (LCG ID).

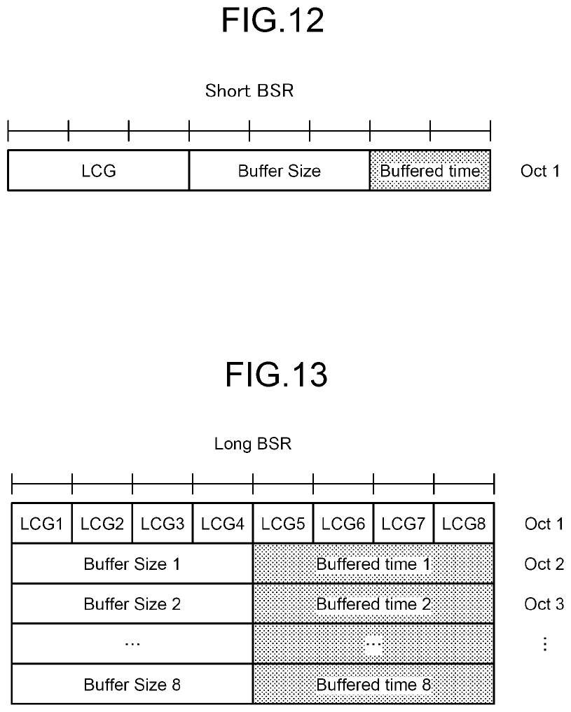

Note that an area (a buffered time area) for notifying residence times may be newly provided by compressing a buffer size area. FIGS. 12 and 13 are diagrams each illustrating another example of a format of a BSR in which residence time information can be stored. FIG. 12 illustrates an example of a short BSR, and FIG. 13 illustrates an example of a long BSR. In each of the examples of FIGS. 12 and 13, an area (a buffered time area) for newly notifying residence times is provided by compressing the 1-octet buffer size area. Although the resolution is inferior to that in the examples illustrated in FIGS. 10 and 11, resources required for notifying residence time information can be reduced.

Note that the value stored in the buffered time area may be a value at an initial transmission timing. Furthermore, the value stored in the buffered time area may be a value on a msec, slot, or subframe basis. The value stored in the buffered time area may be a table reference value.

The terminal device 40 may use the area (buffered time area) by default or may use the area only when a predetermined condition is satisfied. That is, the terminal device 40 may transmit residence time information to the base station 30 only when the predetermined condition is satisfied. For example, when the delay requirement satisfies a predetermined criterion (for example, when the packet delay budget requirement is XX msec or less (e.g., 10 msec or less) in 5QI/QCI,), the terminal device 40 may incorporate residence time information in a BSR and transmit the BSR to the base station 30. Alternatively, when the slice to be used is a low latency slice, the terminal device 40 may incorporate residence time information in a BSR and transmit the BSR to the base station 30. Of course, the terminal device 40 may be configured to transmit a residence time to the base station 30 regardless of whether the delay requirement satisfies the predetermined criterion.

### 3-4. Example of Sequence

Based on the above, communication processing executed by the communication system 1 according to the first embodiment will be described.

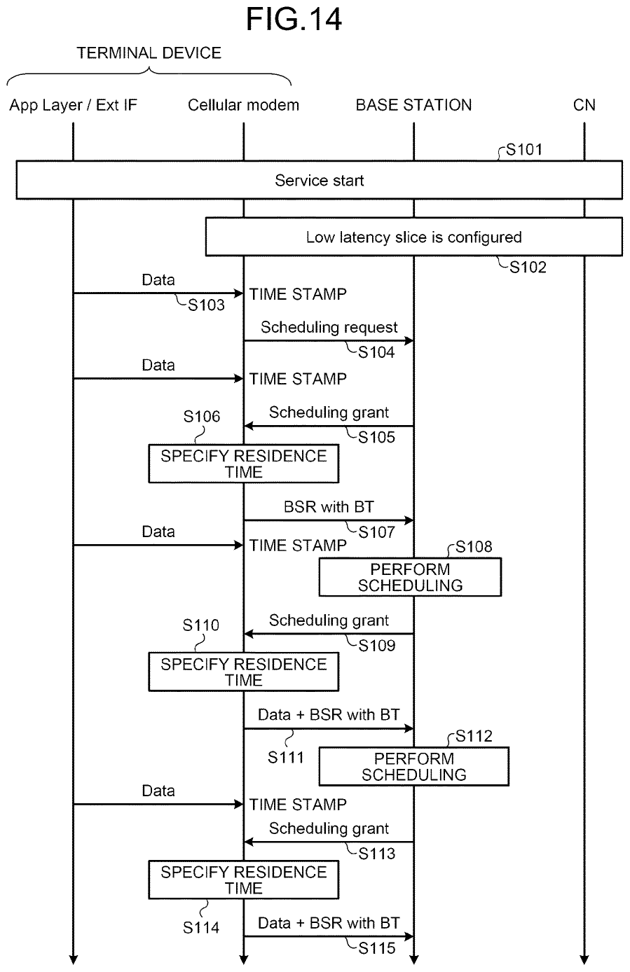

FIG. 14 is a sequence diagram illustrating communication processing according to the first embodiment. The terminal device 40 illustrated in FIG. 14 is configured such that data to be transmitted is generated therein (APP Layer in the drawing). Furthermore, the terminal device 40 is configured to receive data to be transmitted from another communication device (e.g., another terminal device 40) via an external interface (Ext IF in the drawing). In the following description, the data to be transmitted may be referred to as transmission data. The communication processing according to the first embodiment will be described below with reference to FIG. 14.

The terminal device 40, the base station 30, and the core network (e.g., the management device 20) execute processing for starting a communication service (for example, initial setting, initial connection processing, etc.) (step S101). The cellular modem (for example, the wireless communication unit 41 and/or the control unit 43) of the terminal device 40, the base station 30, and the core network construct a low latency slice (step S102).

When transmission data is generated inside the terminal device 40 (alternatively, when transmission data is received from another communication device), the terminal device 40 transmits the data to the cellular modem (step S103). When receiving the data, the cellular modem of the terminal device 40 timestamps a data reception time. For example, the cellular modem (e.g., the measurement unit 433) may assign a data reception time to the received data, or may manage a data reception time separately from the data. Then, the terminal device 40 stores the received data (packet) in the buffer. Thereafter, the terminal device 40 repeats this operation (hereinafter, the description of this operation will be omitted).

Next, the terminal device 40 makes a scheduling request to the base station 30 (step S104). The base station 30 performs scheduling for uplink communication and issues a scheduling grant to the terminal device 40 (step S105).

Next, the terminal device 40 specifies a residence time of the data (packet) stored in the buffer. For example, the terminal device 40 specifies at least one of an average residence time, a maximum residence time, and a predicted residence time (step S106). In the following description, it is assumed that the terminal device 40 specifies a maximum residence time as an example. The terminal device 40 incorporates residence time information including information regarding the maximum residence time in a BSR and transmits the BSR to the base station 30 (step S107).

The base station 30 receives residence time information from each of the plurality of terminal devices 40. The base station 30 that has received the residence time information performs scheduling based on the residence time information (e.g., the maximum residence time) (step S108). Note that the base station 30 may hold a time at which the residence time information was received and correct the received residence time information at a scheduling timing.

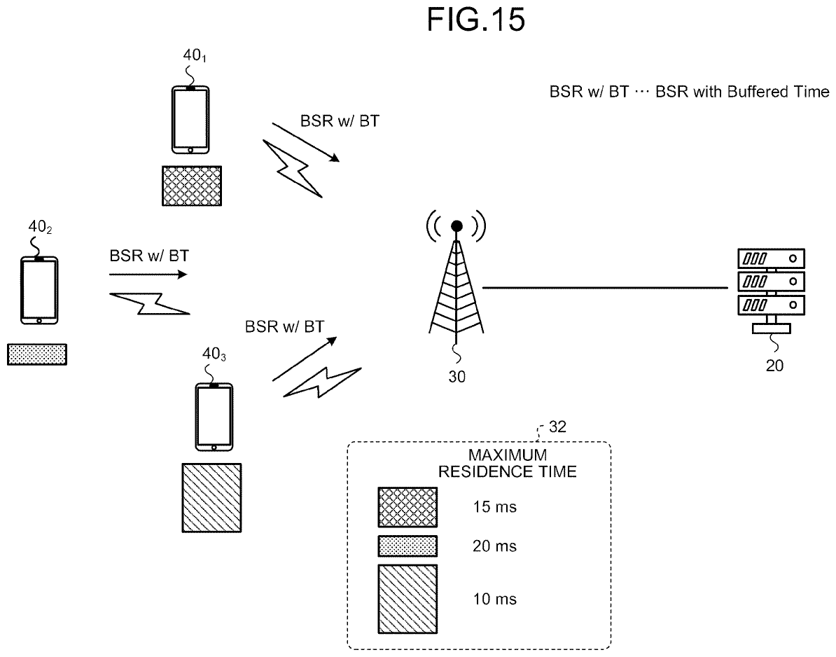

FIG. 15 is a diagram for explaining scheduling in consideration of a residence time. By receiving the residence time information from the terminal device 40, the base station 30 can recognize which terminal device 40 has a buffer where the data residence time is large. The base station 30 can use the residence time information as a scheduling coefficient. In the example of FIG. 15, since the residence time of the terminal device 402 is 20 ms, which is the largest, the base station 30 assigns radio resources preferentially to the terminal device 402.

Returning to FIG. 14, the base station 30 issues a scheduling grant to the terminal device 40 based on the scheduling result (step S109).

Next, the terminal device 40 specifies a residence time of data (packet) stored in the buffer (step S110). Then, the terminal device 40 stores residence time information including information regarding a maximum residence time in a BSR. The terminal device 40 transmits data together with the BSR to the base station 30 based on the scheduling grant (step S111).

The base station 30 receives the BSR transmitted together with the data (packet) from the terminal device 40. Then, the base station 30 performs scheduling based on the residence time information included in the BSR (step S112). The base station 30 issues a scheduling grant to the terminal device 40 based on the scheduling result (step S113).

The terminal device 40 specifies a residence time of data (packet) stored in the buffer (step S114). Then, the terminal device 40 transmits data together with a BSR in which residence time information is stored to the base station 30 (step S115).

According to the first embodiment, the base station 30 can grasp residence of data buffered in each terminal device 40. Accordingly, the base station 30 can perform scheduling in consideration of the residence time. As a result, since low-delay wireless communication is realized in uplink communication as well, the communication system 1 can realize wireless communication with high communication performance (e.g., stable low-delay wireless communication).

### 4. Second Embodiment

Next, an operation of a communication system 1 according to the second embodiment will be described.

### 4-1. Example of Functional Configuration

First, an example of a functional configuration of a communication device according to the second embodiment will be described. The communication devices (terminal device 40 and base station 30) according to the second embodiment can be configured as follows.

### Example of Functional Configuration of Terminal Device

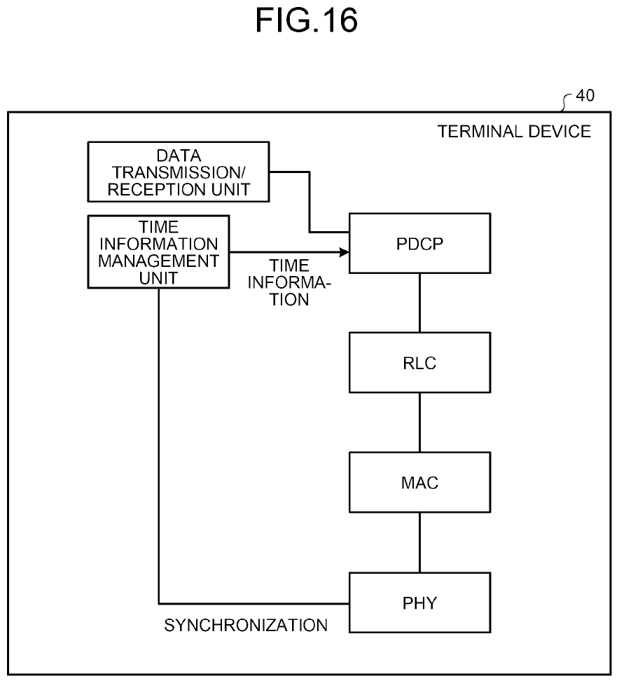

FIG. 16 is a functional block diagram of a terminal device 40 according to the second embodiment. The terminal device 40 includes a block that performs processing on a PDCP layer (PDCP illustrated in FIG. 16), a block that performs processing on an RLC layer (RLC illustrated in FIG. 16), a block that performs processing on an MAC layer (MAC illustrated in FIG. 16), and a block that performs processing on a physical layer (PHY illustrated in FIG. 16). These blocks can be realized by, for example, the wireless communication unit 41 and the control unit 43 illustrated in FIG. 8. Furthermore, the terminal device 40 includes a data transmission/reception unit. This block can be realized by, for example, the transmission unit 431 and the reception unit 432 illustrated in FIG. 8. Furthermore, the terminal device 40 includes a time information management unit. This block can be realized by, for example, the measurement unit 433 and the storage unit 42 illustrated in FIG. 8. The time information management unit notifies the PDCP of time information. The time information managed by the time information management unit is, for example, a frame number. The time information management unit synchronizes the frame number with the PHY.

### Example of Functional Configuration of Base Station

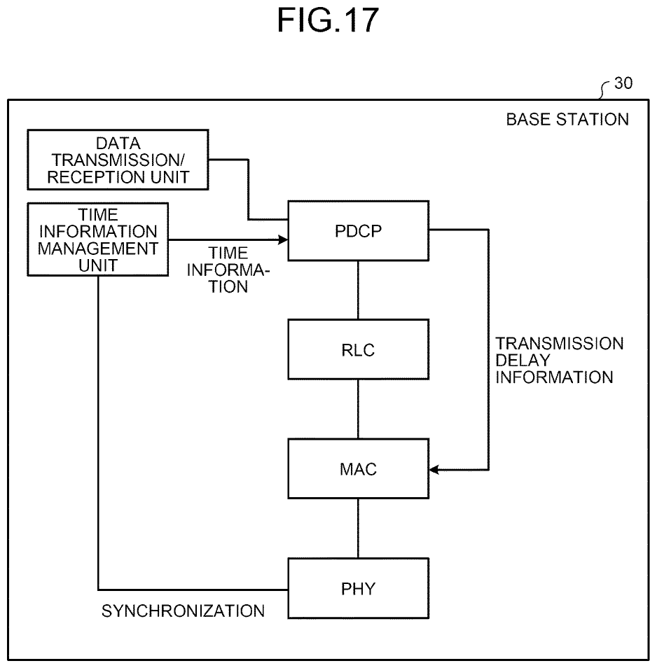

FIG. 17 is a functional block diagram of a base station 30 according to the second embodiment. The base station 30 includes a block that performs processing on a PDCP layer (PDCP illustrated in FIG. 17), a block that performs processing on an RLC layer (RLC illustrated in FIG. 17), a block that performs processing on an MAC layer (MAC illustrated in FIG. 17), and a block that performs processing on a physical layer (PHY illustrated in FIG. 17). These blocks can be realized by, for example, the wireless communication unit 31 and the control unit 33 illustrated in FIG. 7. In addition, the base station 30 includes a data transmission/reception unit. This block can be realized by, for example, the transmission unit 331 and the reception unit 332 illustrated in FIG. 7. In addition, the base station 30 includes a time information management unit. This block can be realized by, for example, the control unit 33 and the storage unit 32 illustrated in FIG. 7. The time information management unit notifies the PDCP of time information. The time information managed by the time information management unit is, for example, a frame number. The time information management unit synchronizes the frame number with the PHY.

### 4-2. Details of Operation

Next, operations of the communication devices (terminal device 40 and base station 30) according to the second embodiment will be described.

In the second embodiment, the terminal device 40 assigns time information (hereinafter, also referred to as a time stamp) to each of one or more packets to be transmitted to another communication device. For example, the terminal device 40 assigns a time stamp to each of one or more packets to be transmitted to the base station 30. For example, when a PDU is generated by the PDCP or the RLC, the terminal device 40 assigns a time stamp (e.g., a PDU generation time) to the PDU. When receiving a packet (PDCP SDU) from the data transmission/reception unit, the terminal device 40 may assign a time stamp (a current time) to the head of the SDU.

At this time, the time stamp may be a system frame number (SFN) or a hyper frame number (HFN), or may be a subframe number. For example, the time stamp may be lower 12 bits of a hyper frame number (HFN) or a subframe number estimated in the PDCP layer. Note that the terminal device 40 may use a slot number, as the time stamp, instead of the subframe number. In a case where the slot number is used as the time stamp, the terminal device 40 extends a time stamp area according to subcarrier spacing (SCS) as will be described later.

Note that the HFN is treated as a self-running counter in the PDCP layer. In a case where a subframe number or a slot number is used as the time stamp, the terminal device 40 may determine the subframe number or the slot number based on an elapsed time from a timing at which an HFN counter is updated. For example, in a case where the timing at which the processing is executed has elapsed 2 msec from the HFN-updated timing, the terminal device 40 sets the subframe number to 1. Here, the subframe number is in units of 1 msec, starting s from 0.

The base station 30 synchronizes time with the terminal device 40 in advance. For example, the base station 30 synchronizes the terminal device 40 with the SFN/HFN in advance using an RRC message or the like. When receiving a packet from the terminal device 40, the base station 30 specifies a time required for the transmission of the packet (hereinafter referred to as a transmission delay time) based on a time stamp added to the packet. For example, when generating a PDCP SDU from the packet, the PDCP of the base station 30 extracts the time stamp (e.g., SFN/HFN/subframe number/slot number) from the packet. Then, the base station 30 specifies a transmission delay time of the packet from a difference between the time stamp and a current time (e.g., SFN/HFN/subframe number/slot number). Note that the terminal device 40 may estimate the subframe number/slot number as the current time based on an elapsed time from the count-up timing of the HFN.

Then, the base station 30 performs scheduling for the terminal device 40 based on information on the specified transmission delay time. For example, the PDCP of the base station 30 notifies an MAC scheduler of the information on the specified transmission delay time. The MAC scheduler performs scheduling for uplink communication based on the information on the transmission delay time.

### 4-3. Format of PDU

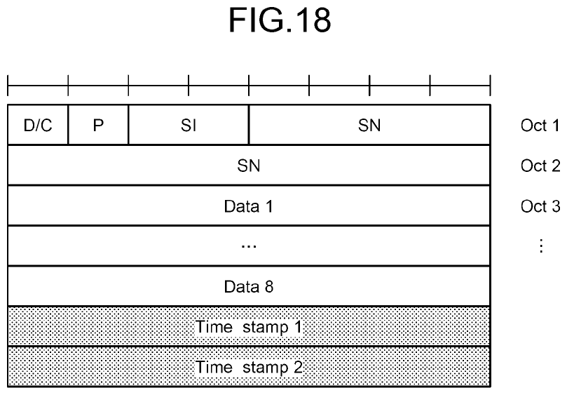

As described above, the terminal device 40 transmits the PDU to which the time stamp is assigned to the base station 30. At this time, a new area for storing the time stamp may be provided in the PDU. FIG. 18 is a diagram illustrating an example of a format of a PDU in which a time stamp can be stored. Specifically, FIG. 18 illustrates an example of a format of an RLC acknowledge mode (AM) PDU in which an area for storing a time stamp (hereinafter referred to as a time stamp area) is newly provided. In FIG. 18, a 2-octet time stamp area is newly provided in the PDU.

### Extension of Time Stamp Area

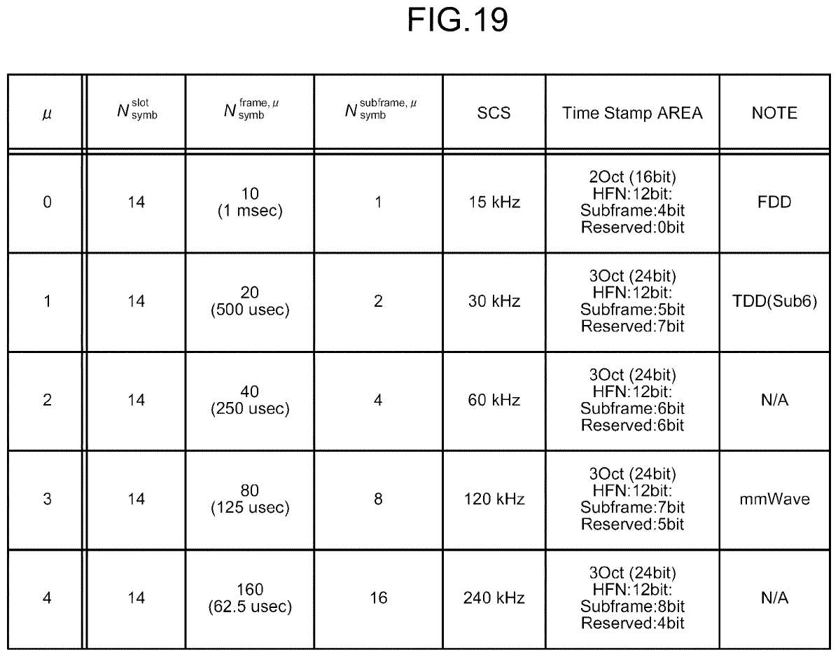

In LTE, the subframe number is unified to 1 msec, but in NR, an actual transmission unit is a slot. In addition, since the slot length varies depending on the subcarrier spacing (SCS) of the target RAT, delay time-measurable granularity varies. FIG. 19 is a diagram for explaining delay time-measurable granularity. FIG. 19 is created with reference to TS 38.211 Table 4.3.2-1 of 3GPP. A time (62.5 usec to 1 msec) indicated in brackets in the drawing is a time of one communication opportunity when a communication scheme described for reference is applied. The terminal device 40 extends the time stamp area when notifying a minimum measurement unit. Note that, the terminal device 40 may prepare a 3-octet time stamp area, and set 8 bits to a reserved area, by combining μ=0 with another μ. Whether to extend the time stamp area may be determined in advance by system setting or the like.

### 4-4. Example of Sequence

Based on the above, communication processing executed by the communication system 1 according to the second embodiment will be described.

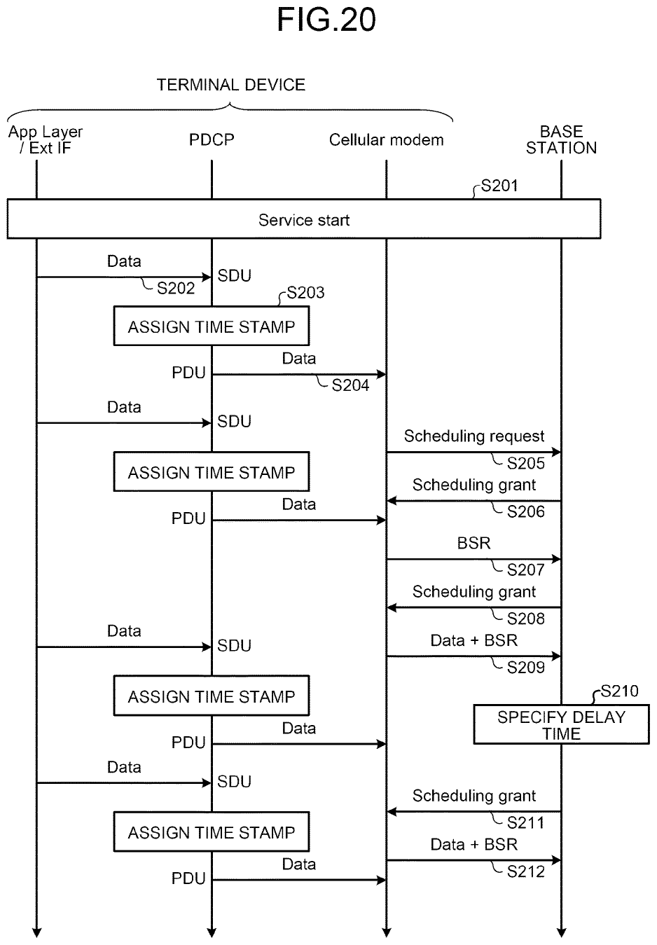

FIG. 20 is a sequence diagram illustrating communication processing according to the second embodiment. The terminal device 40 illustrated in FIG. 20 is configured such that data to be transmitted is generated therein (APP Layer in the drawing). Furthermore, the terminal device 40 is configured to receive data to be transmitted from another communication device (e.g., another terminal device 40) via an external interface (Ext IF in the drawing). In the following description, the data to be transmitted may be referred to as transmission data. In the example of FIG. 20, it is assumed that the HFN is synchronized between the base station 30 and the terminal device 40 by an RRC message or the like. The communication processing according to the second embodiment will be described below with reference to FIG. 20.

The terminal device 40, the base station 30, and the core network (e.g., the management device 20) execute processing for starting a communication service (for example, initial setting, initial connection processing, etc.) (step S201).

When transmission data is generated inside the terminal device 40 (alternatively, when transmission data is received from another communication device), the terminal device 40 generates an SDU based on the transmission data and transmits the SDU to the PDCP (step S202). The PDCP of the terminal device 40 generates a PDU based on the received SDU and assigns a time stamp to the PDU (step S203). Then, the PDCP of the terminal device 40 transmits the PDU to which the time stamp is assigned to the cellular modem (step S204). Then, the cellular modem stores the received PDU in the buffer. Thereafter, the terminal device 40 repeats this operation (hereinafter, the description of this operation will be omitted).

Next, the terminal device 40 makes a scheduling request to the base station 30 (step S205). The base station 30 performs scheduling for uplink communication and issues a scheduling grant to the terminal device 40 (step S206). The terminal device 40 transmits a BSR to the base station 30 based on the grant (step S207). The base station 30 performs scheduling for uplink communication and issues a scheduling grant to the terminal device 40 (step S208). The terminal device 40 transmits the data (the PDU to which the time stamp is assigned) to the base station 30 based on the grant (step S209). At this time, the terminal device 40 may transmit a BSR together with the data.

The base station 30 receives data (a PDU to which a time stamp is assigned) from each of the plurality of terminal devices 40. The base station 30 extracts the time stamp from the PDU and specifies a delay time based on the time stamp (step S210). Then, the base station 30 performs scheduling based on the specified delay time (e.g., a maximum delay time or an average delay time).

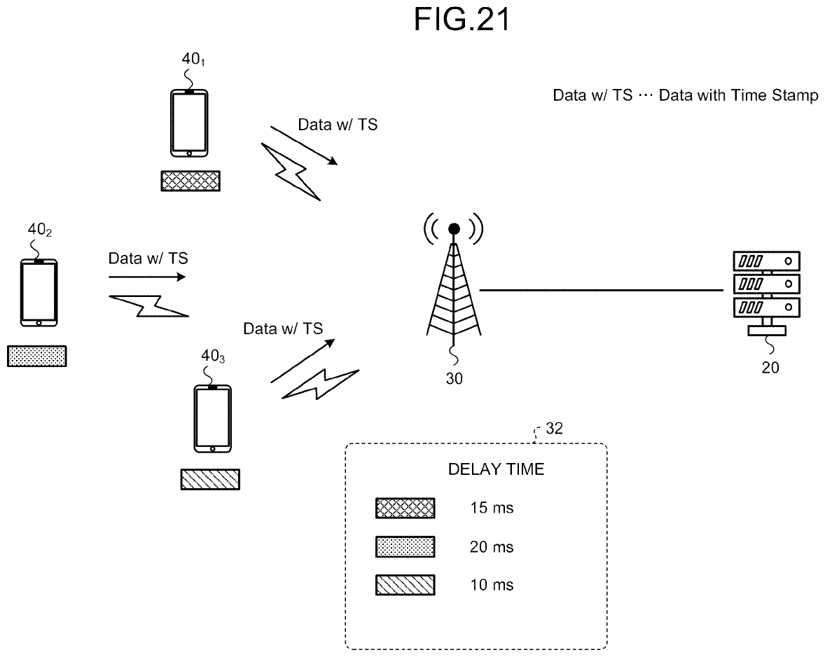

FIG. 21 is a diagram for explaining scheduling in consideration of a delay time. The base station 30 specifies a transmission delay time of the PDU from a difference between the time stamp extracted from the PDU and a current time (e.g., HFN). Note that the delay time specified by the base station 30 may be an average delay time of a plurality of packets or a maximum delay time of a plurality of packets. Furthermore, the delay time specified by the base station 30 may be a delay time (an average delay time or a maximum delay time) for each LCG. By receiving the delay time information from the terminal device 40, the base station 30 can recognize which terminal device 40 has a longer delay time. The base station 30 can use the delay time information as a scheduling coefficient. In the example of FIG. 21, since the delay time of the terminal device 402 is 20 ms, which is the largest, the base station 30 assigns radio resources preferentially to the terminal device 402.

Returning to FIG. 20, the base station 30 issues a scheduling grant to the terminal device 40 based on the scheduling result (step S211). The terminal device 40 transmits the data (the PDU to which the time stamp is assigned) to the base station 30 based on the grant (step S212).

According to the second embodiment, the base station 30 can grasp a transmission delay time of each terminal device 40. Accordingly, the base station 30 can perform scheduling in consideration of the delay time. As a result, since low-delay wireless communication is realized in uplink communication as well, the communication system 1 can realize wireless communication with high communication performance (e.g., stable low-delay wireless communication).

### 5. Third Embodiment

Next, an operation of a communication system 1 according to the third embodiment will be described.

### 5-1. Example of Functional Configuration

First, an example of a functional configuration of a communication system according to the third embodiment will be described. The communication system (communication system 1) according to the third embodiment can be configured as follows.

### Example of Functional Configuration of Communication System

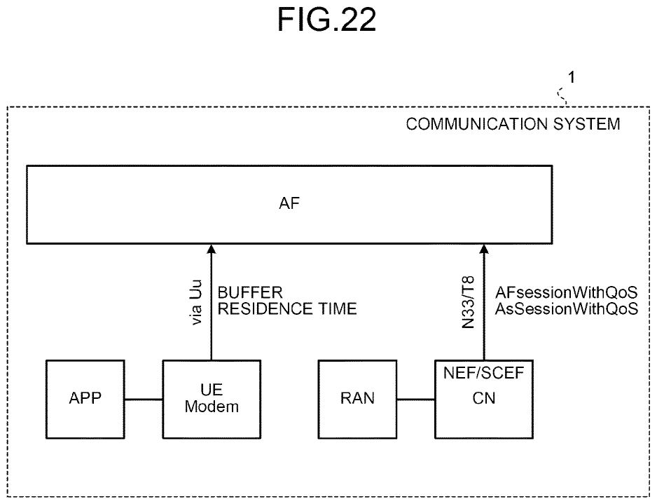

FIG. 22 is a functional block diagram of the communication system 1 according to the third embodiment. The communication system 1 includes an application function (AF illustrated in FIG. 22), a core network (CN illustrated in FIG. 22), a radio access network (RAN illustrated in FIG. 22), a block that performs processing on an application layer (App illustrated in FIG. 22), and a wireless communication function of user equipment (UE Modem illustrated in FIG. 22). AF can be realized by, for example, the server 10 illustrated in FIG. 4. Core can be realized by, for example, the management device 20 illustrated in FIG. 4. RAN can be realized by, for example, the base station 30 illustrated in FIG. 4. App and UE Modem can be realized by, for example, the terminal device 40 illustrated in FIG. 4. App and UE Modem may be constituted by one terminal device 40 or may be constituted by separate terminal devices 40. UE Modem may be referred to as a cellular modem.

### Example of Functional Configuration of Terminal Device

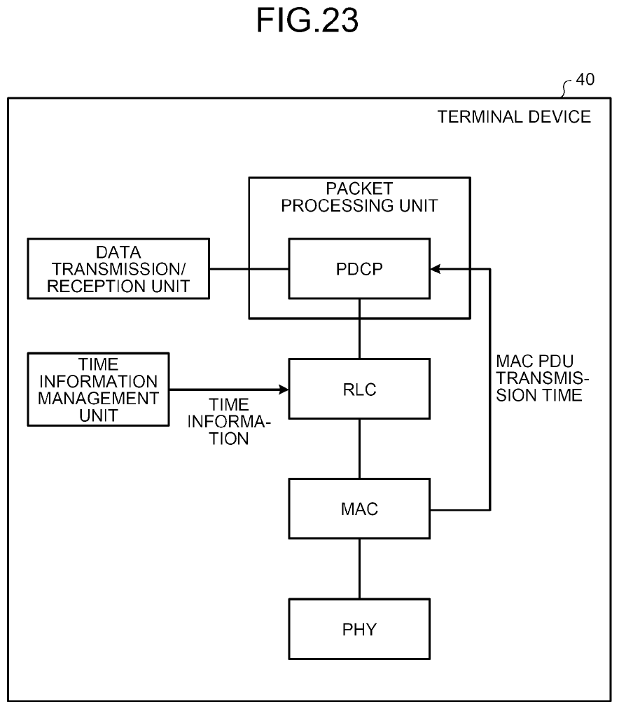

As described above, UE Modem may be realized by the terminal device 40. FIG. 23 is a functional block diagram of a terminal device 40 according to the third embodiment. The terminal device 40 includes a data transmission/reception unit, a time information management unit, a packet processing unit, a block that performs processing on an RLC layer (RLC illustrated in FIG. 23), a block that performs processing on an MAC layer (MAC illustrated in FIG. 23), and a block that performs processing on a physical layer (PHY illustrated in FIG. 23). The packet processing unit includes a block that performs processing on a PDCP layer (PDCP illustrated in FIG. 23). The data transmission/reception unit can be realized by, for example, the transmission unit 431 and the reception unit 432 illustrated in FIG. 8. The time information management unit can be realized by, for example, the measurement unit 433 and the storage unit 42 illustrated in FIG. 8. The packet processing unit to the PHY can be realized by, for example, the wireless communication unit 41 and the control unit 43 illustrated in FIG. 8.

The data transmission/reception unit is an interface with the App. The data transmission destination/data reception source of the data transmission/reception unit may be a communication device (external App) in a casing separate from the terminal device 40. Furthermore, the data transmission destination/data reception source of the data transmission/reception unit may be an internal block (internal App) of the terminal device 40. For example, the data transmission destination/data reception source may be an App processor, a sensor, or the like in the same casing.

The time information management unit manages times by self-running. Alternatively, the time information management unit manages times based on an external source. Since it is sufficient to know a difference between two times (a residence time of data (packet) stored in the buffer) in the terminal device 40, the time information management unit may manage the times by a self-running clock as long as relative times can be correctly managed.

When a UL packet is received from the data transmission/reception unit, the packet processing unit stores a time at which the UL packet is received. Then, the packet processing unit receives, from the MAC, a time at which the last (or initial) MAC PDU among a plurality of MAC PDUs related to the packet was transmitted. Then, the packet processing unit calculates a residence time of the data (packet) stored in the buffer based on the reception time of the UL packet and the transmission time of the MAC PDU. The packet processing unit notifies the AF of a residence time every pre-determined period of time.

### Example of Functional Configuration of Server

As described above, AF can be realized by the server 10. AF may be a part of the function of the core network. In this case, AF can be realized by the management device 20. Of course, AF may be realized by an information processing device (computer) other than the server 10 and the management device 20. In the following description, it is assumed as an example that AF is realized by the server 10.

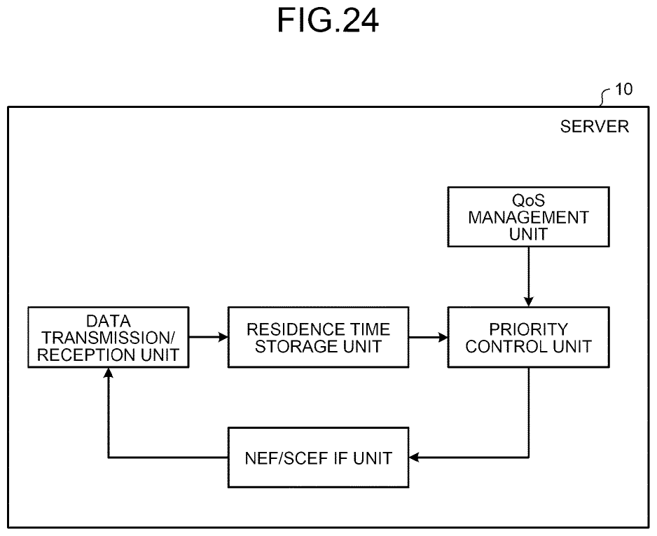

FIG. 24 is a functional block diagram of the server 10 according to the third embodiment. The server 10 includes a data transmission/reception unit, a residence time storage unit, a QoS management unit, a priority control unit, and a network exposure function (NEF)/service capability exposure function (SCEF) interface unit. These blocks can be realized by, for example, the communication unit 11, the storage unit 12, and the control unit 13 illustrated in FIG. 5.

The data transmission/reception unit has a function of receiving a residence time notified from the packet processing unit of the terminal device 40. In addition, the data transmission/reception unit may function as an interface with the NEF/SCEF of the core network. These two functions may be independent.

The residence time storage unit stores a residence time notified from the terminal device 40. The residence time storage unit manages a representative value (e.g., a maximum value or the like in a predetermined period of time) for each terminal device 40.

The QoS management unit manages a target service level (a target delay time) of a service/application used by the terminal device 40.

The priority control unit compares the residence time stored in the residence time management unit with the service level managed by the QoS management unit for each terminal device 40. The priority control unit notifies the NEF/SCEF interface unit to raise a priority of a terminal device 40 that does not satisfy the service level. Furthermore, the priority control unit may make a determination to lower a priority of a terminal device 40 sufficiently satisfying the service level.

The NEF/SCEF interface unit notifies the core network of the change in target priority using an application programming interface (API) concerning the terminal device 40 of which the change in priority has been notified.

### 5-2. Details of Operation

Next, an operation of a communication system 1 according to the second embodiment will be described.

In the third embodiment, the terminal device 40 measures residence times of one or more packets to be transmitted to another communication device (e.g., the base station 30) for the respective packets. Then, the terminal device 40 notifies the AF (e.g., the server 10) of residence time information including information regarding the residence times. Similarly to the first embodiment, the residence time notified to the AF may be an average residence time, a maximum residence time, a predicted residence time, or a combination thereof. The residence time may be a representative value (e.g., a maximum value or the like in a predetermined period of time). The residence time notified to the AF may be a residence time for each LCG (alternatively, for each logical channel).

The AF resets a quality of service (QoS) related to the terminal device 40 based on the notified residence time information. For example, the AF resets a QoS (CQI/5QI) in accordance with a delay budget set for each service by using NEF_AfsessionWithQoS based on the information on the residence times of the plurality of terminal devices 40 and the service level agreement (SLA) of each service. The base station 30 performs scheduling for uplink communication based on the changed QoS.

### 5-3. Example of Sequence

Based on the above, communication processing executed by the communication system 1 according to the third embodiment will be described.

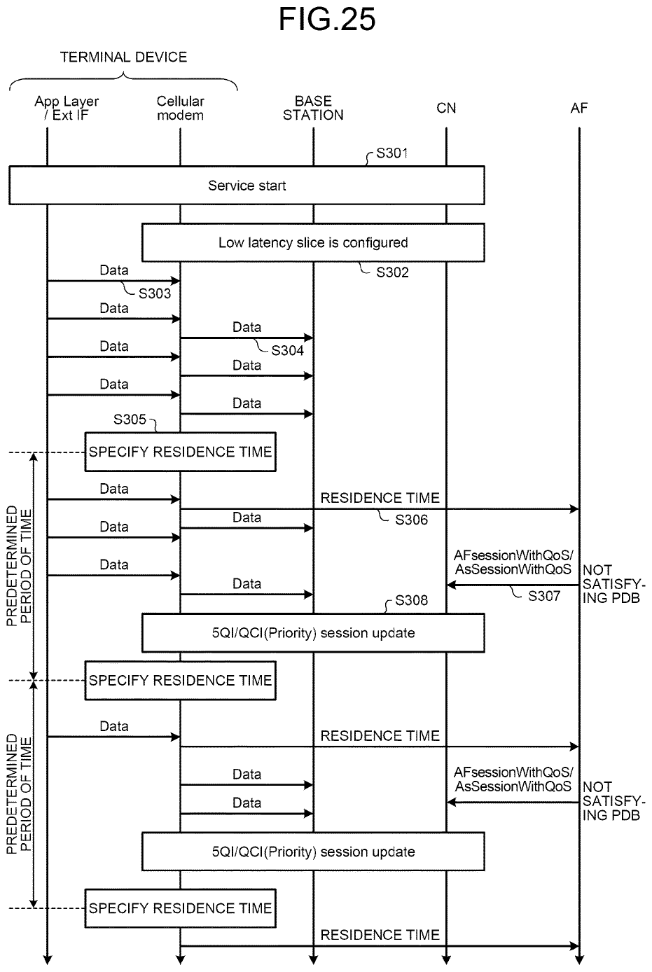

FIG. 25 is a sequence diagram illustrating communication processing according to the third embodiment. The terminal device 40 illustrated in FIG. 25 is configured such that data to be transmitted is generated therein (APP Layer in the drawing). Furthermore, the terminal device 40 is configured to receive data to be transmitted from another communication device (e.g., another terminal device 40) via an external interface (Ext IF in the drawing). In the following description, the data to be transmitted may be referred to as transmission data. The communication processing according to the third embodiment will be described below with reference to FIG. 25.

The terminal device 40, the base station 30, and the core network (e.g., the management device 20) execute processing for starting a communication service (for example, initial setting, initial connection processing, etc.) (step S301). The cellular modem (for example, the wireless communication unit 41 and/or the control unit 43) of the terminal device 40, the base station 30, and the core network construct a low latency slice (step S302).

When transmission data is generated inside the terminal device 40 (APP Layer) (alternatively, when the external interface 44 receives transmission data from another communication device), the terminal device 40 transmits the data to the cellular modem inside the terminal device 40 (step S303). The terminal device 40 converts the data into a packet (SDU/PDU) of a predetermined format, and stores the converted packet in the buffer. Then, the terminal device 40 transmits the packet in the buffer to the base station 30 based on a grant issued from the base station 30 (step S304). Thereafter, the terminal device 40 repeats this operation (hereinafter, the description of this operation will be omitted).

Subsequently, the terminal device 40 specifies residence times of one or more packets stored in the buffer (step S305). For example, the terminal device 40 calculates a standby time of the packet in the RLC layer/MAC layer. Note that, similarly to the first embodiment, the residence time specified by the terminal device 40 may be an average residence time, a maximum residence time, a predicted residence time, or a combination thereof. The residence time may be a representative value (e.g., a maximum value or the like in a predetermined period of time). The residence time notified to the AF may be a residence time for each LCG (alternatively, for each logical channel). The terminal device 40 notifies the AF (e.g., the server 10) of information regarding the specified residence time (hereinafter referred to as residence time information) (step S306). Thereafter, the terminal device 40 periodically repeats this operation (steps S305 and S306) (hereinafter, the description of this operation will be omitted).

The AF receives the residence time information from the terminal device 40. Then, the AF determines whether the communication (e.g., communication related to a service provided by the AF) of the terminal device 40 satisfies the delay requirement based on the residence time information. For example, the AF determines whether the communication (e.g., uplink communication) of the terminal device 40 satisfies a packet delay budget (PDB) based on a request for the service. When the residence time is longer than the PDB (for example, when the residence time does not satisfy a first criterion), the scheduling priority of the terminal device 40 is set to be high. When the standby time is sufficiently satisfied (when the residence time satisfies a second criterion that is stricter than the first criterion), the scheduling priority of the terminal device 40 is set to be low within a range in which the PDB can be assumed to be satisfied.

Then, the AF notifies the core network of the change in target priority concerning the terminal device 40 of which the priority has been changed (step S307). For example, the AF resets a quality of service (QOS) related to the terminal device 40 using a predetermined API. For example, the AF updates the QoS (e.g., a 5G QoS identifier (5QI), a QoS class identifier (QCI), a priority level thereof, or a packet delay budget) configured in the core network by using an NEF API (e.g., AFsessionWithQoS) or an SCEF API (e.g., AsSessionWithQoS). The core network (e.g., the management device 20) and/or the base station 30 updates the QoS for the terminal device 40 based on the notification from the AF (step S308). The base station 30 performs scheduling for the terminal device 40 based on the changed QoS. Thereafter, the AF, the core network, and the base station 30 repeat this operation (steps S307 and S308).

Although the base station 30 and the core network usually perform scheduling to meet the set QoS, the QoS may not be met depending on a congestion situation. In this case, the weighting of the scheduling metric may be dynamically changed by more significantly increasing or decreasing the QoS setting of the service. As a result, the base station 30 and the core network can achieve the target delay time.

According to the third embodiment, the AF can grasp residence of data buffered in each terminal device 40. Accordingly, the AF can reset the QoS in consideration of the residence time. As a result, since low-delay wireless communication is realized in uplink communication as well, the communication system 1 can realize wireless communication with high communication performance (e.g., stable low-delay wireless communication).

### 6. Modifications

The above-described embodiments are examples, and various modifications and ap-plications can be made.

### 6-1. Modification Related to Specification of Residence Time

In the above-described embodiments (the first to third embodiments), the terminal device 40 specifies a residence time of a packet to be transmitted to another communication device in the terminal device 40. The residence time can be specified (calculated) as follows.

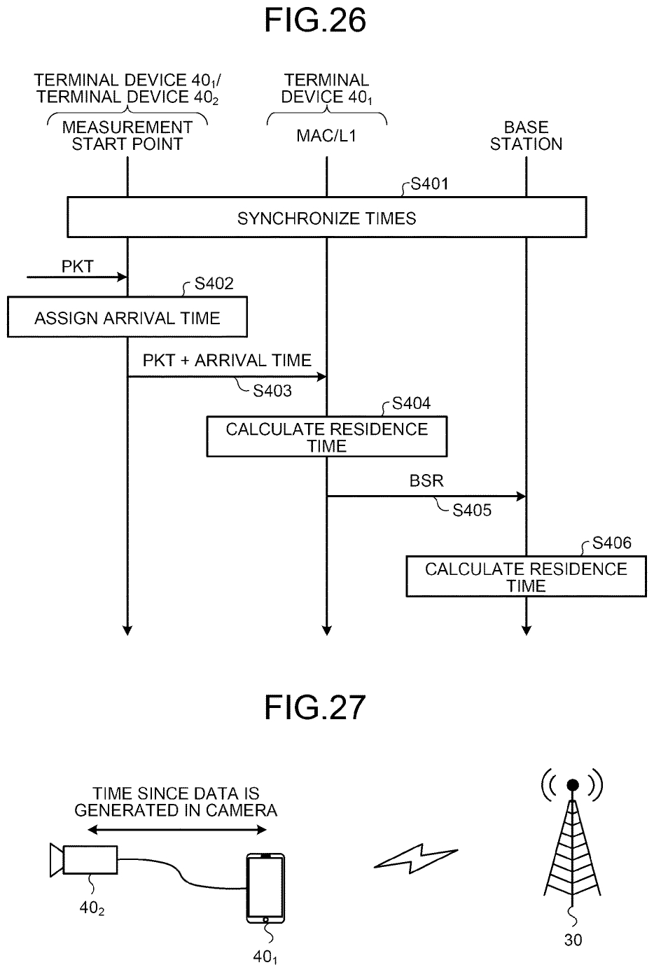

FIG. 26 is a sequence diagram for explaining a method of specifying a residence time. In the drawing, MAC/L1 is a MAC layer/a physical layer of the terminal device 40₁ that transmits data to the base station 30. The measurement start point is, for example, one of the following (1) to (3).
(1) PDCP/RLC hierarchical boundary (3GPP protocol boundary)
(2) Interface of smartphone (boundary between App and OS), router, or IoT module
(3) External device connected to terminal device 40₁

Here, the external device may be a communication device (e.g., the terminal device 40₂) connected to the terminal device 40₁ by tethering/LAN or the like and generating a packet/data. FIG. 27 is a diagram for explaining an external device. In the example of FIG. 27, the external device (terminal device 40₂) is a camera. In this case, the terminal device 40₁ may specify a time since data is generated in the external device as the residence time. Of course, the terminal device 40₁ may specify a time since a packet is generated by an application in the terminal device 40₁ as the residence time. In addition, the terminal device 40₁ may specify a time since a packet reaches a predetermined protocol layer (e.g., the PDCP layer or the RLC layer) in the terminal device 40₁ as the residence time.

Hereinafter, a method of specifying a residence time will be described with reference to the sequence diagram of FIG. 26.

First, the measurement start point and the MAC/L1 synchronize times (step S401). The measurement start point and the MAC/L1 may periodically share a common counter (e.g., a counter of the CPU) and time information.

Next, when a transmission packet arrives at the measurement start point, the measurement start point assigns an arrival time to the transmission packet (step S402). The timing at which the transmission packet arrives at the measurement start point is a measurement start timing of a residence time. The measurement start point transmits the packet to which the arrival time is assigned to the MAC/L1 (step S402).

Next, the MAC/L1 calculates a residence time of the transmission packet in the terminal device 40 (step S404). Here, the measurement end timing of the residence time is a first BSR-transmitted time (e.g., SFN/Subframe/Slot in which a BSR is transmitted for the first time). That is, the MAC/L1 specifies a time from the arrival time (measurement start timing) to the first BSR-transmitted time (measurement end timing) as the residence time. The BSR is transmitted to the base station 30 at an allocated timing. Therefore, the MAC/L1 can uniquely determine the first BSR-transmitted time when creating the BSR. The MAC/L1 notifies the base station 30 of the specified residence time through the BSR (step S405).

The base station 30 calculates a processing standby time (scheduling standby time) in the base station 30 based on the first BSR-transmitted time and a time (estimated time) at which scheduling information related to the BSR is transmitted to the terminal device 40. The base station 30 updates the residence time based on the processing standby time (step S406). The base station 30 performs scheduling based on the updated residence time information.

### 6-2. Modification Related to Transmission of Residence Time Information

In the above-described embodiment (the first embodiment), the terminal device 40 notifies another communication device (e.g., the base station 30) of residence time information by using a BSR. However, the terminal device 40 may notify another communication device of residence time information (e.g., an average residence time or a predicted residence time) using a means other than the BSR. The residence time information may include a maximum residence time. The notification means may be any one of the following means A to C.

### Means A

As described in the third embodiment, the terminal device 40 notifies the AF of residence time information.

### Means B

The terminal device 40 notifies radio resource management (RRM) of residence time information through a measurement report (L3 message).

The RRM updates various parameters of the MAC scheduler and notifies the MAC scheduler of the base station 30 of the updated parameters. At this time, since the QoS parameter is a parameter of the core network (policy and charging rules function (PCRF)/policy control function (PCF)), the RRM does not need to change the QoS parameter. The base station 30 is closed within the base station 30 and performs priority control of UE/LCH (logical channel).

The RRM notifies the core network of residence time information. A predetermined function of the core network (e.g., a function of determining a policy such as PCRF/PCF) updates QoS information within the PDU session. As a result, the core network changes the scheduling priority.

An O-CU-CP (RRC layer) defined by an open radio access network (O-RAN) notifies the rAPP using O1. Alternatively, the O-CU-CP (RRC layer) defined by O-RAN notifies xAPP using E2. Here, the O-CU-CP is an O-RAN central unit control plane. Further, rApp is a non-RT RIC application, and xAPP is a near-RT RIC application. The rApp and/or the xApp configure the MAC scheduler (distributed unit (DU)) via the E2 node.

### Means C

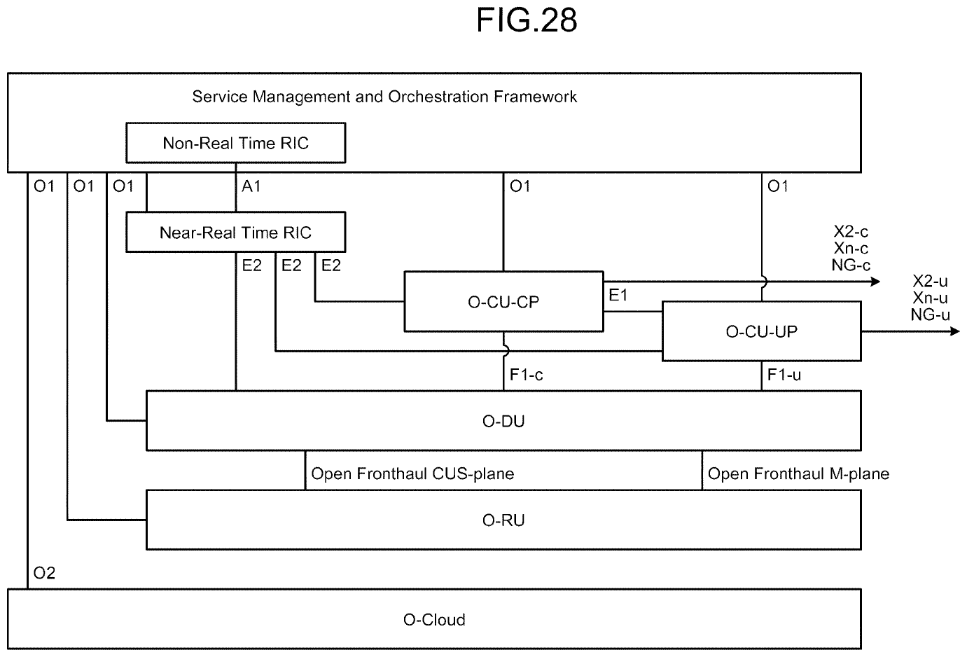

FIG. 28 is a diagram illustrating an example of an O-RAN architecture. The terminal device 40 notifies xApp/rApp (ran intelligent controller (RIC)/service management and orchestration (SMO)) defined by an open radio access network (O-RAN) of residence time information. Here, rApp is a non-RT RIC application, and xAPP is a near-RT RIC application. xApp/rApp (RIC/SMO) configure the MAC scheduler (distributed unit (DU)) via the E2 node. At this time, an interface (via O2) with an external network may be provided to the SMO, and the terminal device 40 notify residence time information using a public line such as the Internet.

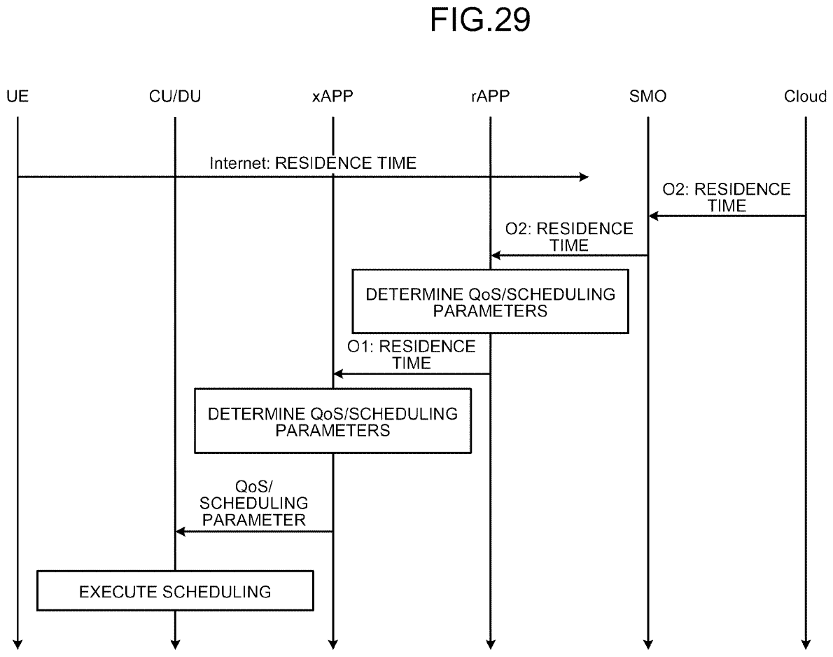

FIG. 29 is a sequence diagram illustrating communication processing using the O-RAN. Specifically, FIG. 29 is a sequence diagram for explaining a scheduling method using xApp/rApp (RIC/SMO). In FIG. 29, user equipment (UE) is, for example, a terminal device 40. The central unit (CU)/distributed unit (DU) is, for example, the base station 30. Hereinafter, the communication processing using the O-RAN will be described with reference to FIG. 29.

The UE transmits residence time information to the SMO via the Internet/cloud or the like. Similarly to the first embodiment, the residence time notified to the SMO may be an average residence time, a maximum residence time, a predicted residence time, or a combination thereof. The residence time may be a representative value (e.g., a maximum value or the like in a predetermined period of time). The residence time notified to the AF may be a residence time for each LCG (alternatively, for each logical channel).

The SMO notifies rApp or xApp in the SMO of the received residence time information. Here, rApp is used in use cases where slow update cycles are acceptable, and xApp is used in use cases where update cycles are fast. If either application can be realized architecturally, it is generally realized by xApp. The rAPP/xAPP compares residence times for the respective services (respective LCHs or respective LCGs)/respective UEs, and specifies a service (LCH or LCG)/UE for which scheduling should be prioritized. Then, rAPP/xAPP determines the QoS parameter/scheduling parameter based on the specified information.

The rAPP/xAPP notifies the CU/DU of the determined QoS parameter/scheduling parameter. The CU/DU reflects the QoS parameter/scheduling parameter in the MAC scheduler.

### 6-3. Modification Related to Transmission of Information Regarding Scheduling

In the above-described embodiments, the terminal device 40 transmits information on residence time (e.g., maximum residence time/average residence time/predicted residence time) to another communication device (the base station 30/AF/SMO), but the terminal device 40 may notify information on a packet information amount in addition to the information on residence time. For example, the terminal device 40 specifies a residence time and an information amount for each uplink packet in addition to the maximum residence time. Then, the terminal device 40 transmits residence time information including at least the information regarding the maximum residence time and the information regarding the residence time and the information amount for each uplink packet to another communication device (e.g., the base station 30/AF/SMO). The residence time information may include information on a total information amount of a plurality of packets held in the buffer.

At this time, the uplink packet may be buffered for each logical channel group (LCG). Then, the terminal device 40 may transmit the residence time information for each LCG to the base station. The residence time information may include information on a total information amount for each LCG.

More specifically, the terminal device 40 may notify another communication device (e.g., the base station 30/AF/SMO) of the number of bits by which the PDCP SDUs are separated and the respective residence times by using a BSR or the like. For example, it is assumed that respective information amounts and residence times for a plurality of packets (PKT #1 to PKT #4) held in the buffer are as follows.
PKT #1: 100 byte, 45 msc
PKT #2: 200 byte, 25 msc
PKT #3: 150 byte, 15 msc
PKT #4: 200 byte, 10 msc

At this time, the terminal device 40 may set the notification contents in the BSR as follows.
Total 550 byte/Max Buffered time 45 msec
100 byte/45 mec
200 byte/25 msec
150 byte/15 msec
100 byte/10 msec

As a result, the base station 30 can perform scheduling with higher accuracy.

### 6-4. Other Modifications

In the above-described embodiments, the base station 30 performs scheduling for uplink communication based on information (residence time information/time stamp) transmitted from the terminal device 40. However, the scheduling performed by the base station 30 is not limited to the scheduling for uplink communication. For example, the base station 30 may perform scheduling for sidelink communication of the terminal device 40 based on information (residence time information/time stamp) transmitted from the terminal device 40. Of course, the base station 30 may perform scheduling for downlink communication of the terminal device 40.

Furthermore, the communication device that performs scheduling is not limited to the base station 30. For example, the communication device that performs scheduling may be another terminal device 40. For example, the communication device that performs scheduling may be a master UE that manages sidelink communication of one or more terminal devices 40 (slave UEs). At this time, the terminal device 40 (slave UE) may transmit information (residence time information/time stamp) regarding the residence of the packet to another terminal device 40 (master UE).

The control device that controls the server 10, the management device 20, the base station 30, or the terminal device 40 according to the present embodiment may be realized by a dedicated computer system or a general-purpose computer system.

For example, a communication program for executing the above-described operation is stored in a computer-readable recording medium, such as an optical disk, a semiconductor memory, a magnetic tape, or a flexible disk, for distribution. Then, the control device is configured, for example, by installing the program in a computer, and executing the above-described processing. At this time, the control device may be a device (e.g., an externally connected computer) outside the server 10, the management device 20, the base station 30, or the terminal device 40. Furthermore, the control device may be a device (e.g., the control unit 13, the control unit 23, the control unit 33, or the control unit 43) inside the server 10, the management device 20, the base station 30, or the terminal device 40.

In addition, the communication program may be stored in a disk device included in a server on a network such as the Internet so that the communication program can be downloaded to a computer. In addition, the above-described functions may be realized by an operating system (OS) and application software in cooperation with each other. In this case, parts other than the OS may be stored in the medium for distribution, or parts other than the OS may be stored in the server and downloaded to a computer.

In addition, among the processes described in the above-described embodiments, all or some of the processes described as being automatically performed can be manually performed, or all or some of the processes described as being manually performed can be automatically performed by known methods. In addition, the processing procedures, the specific terms, and the information including various kinds of data and parameters described hereinabove and illustrated in drawings can be arbitrarily changed unless otherwise specified. For example, the various kinds of information illustrated in each of the drawings are not limited to the illustrated information.

In addition, each component of each device illustrated in the drawings is functionally conceptual, and is not necessarily configured as illustrated in the drawings in physical term. That is, the specific form in which the devices are distributed or integrated is not limited to what is illustrated, and all or some of the devices can be configured to be functionally or physically distributed or integrated in an arbitrary unit according to various loads, usage conditions, and the like. Note that this distributed or integrated configuration may be performed dynamically.

In addition, the above-described embodiments can be appropriately combined unless any processing contradiction is caused. Furthermore, the order of the steps illustrated in each of the flowcharts and the sequence diagrams of the above-described embodiments can be changed as appropriate.

Furthermore, for example, the present embodiment can be implemented as any configuration constituting the device or the system, for example, a processor as a system large scale integration (LSI) or the like, a module using a plurality of processors or the like, a unit using a plurality of modules or the like, or a set obtained by further adding other functions to the unit.

Note that, in the present embodiment, the system refers to a set of a plurality of components (devices, modules (parts), or the like), and it does not matter whether all the components are in the same housing. Therefore, both a plurality of devices housed in separate housings and connected to each other through a network and one device including a plurality of modules housed in one housing are referred to as systems.

Furthermore, for example, the present embodiment can adopt a cloud computing configuration in which one function is shared and processed by a plurality of devices in cooperation with each other via a network.

### 7. Conclusion

The terminal device 40 measures residence times of one or more uplink packets to be transmitted to the base station 30 for the respective packets, and specifies a residence time of a packet (e.g., a maximum value of the residence times) in the terminal device 40. Then, the terminal device 40 transmits residence time information to the base station 30. The base station 30 performs scheduling for uplink communication of the terminal device 40 based on the received residence time information.

Therefore, the base station 30 can schedule uplink communication so as to satisfy the delay requirement. As a result, since low-delay wireless communication is realized in uplink communication as well, the communication system 1 can realize wireless communication with high communication performance (e.g., stable low-delay wireless communication).

Although the embodiments of the present disclosure have been described above, the technical scope of the present disclosure is not limited to each of the above-described embodiments as it is, and various modifications can be made without departing from the gist of the present disclosure. In addition, components in the different embodiments and modifications may be appropriately combined.

Furthermore, the effects of each of the embodiments described in the present specification are merely exemplary and are not restrictive, and each of the embodiments described in the present specification may have other effects.

Note that the present technology can also take the following configurations:

(1)

A terminal device connected to a base station, the terminal device comprising:
a measurement unit that measures residence times of one or more packets transmitted by the terminal device for the respective packets;
a specification unit that specifies a maximum value of the residence times; and
a transmission unit that transmits residence time information including at least information regarding the maximum value of the residence times to the base station.
   (2)

The terminal device according to (1), wherein
the measurement unit measures residence times of one or more uplink packets transmitted by the terminal device for the respective uplink packets, and
the transmission unit transmits the residence time information to the base station.
   (3)

The terminal device according to (2), wherein
the measurement unit measures, as the residence time, a time since the uplink packet is generated by an application in the terminal device.
   (4)

The terminal device according to (2), wherein
the measurement unit measures, as the residence time, a time since the uplink packet arrives at a predetermined protocol layer.
   (5)

The terminal device according to (2), wherein
the measurement unit measures, as the residence time, a time since the uplink packet is generated on another communication device connected to the terminal device.
   (6)

The terminal device according to any one of (2) to (5), wherein
the transmission unit incorporates the residence time information in a BSR and transmits the BSR to the base station.
   (7)

The terminal device according to (6), wherein
the maximum value of the residence times is acquired at a timing when the transmission of the BSR is triggered, and the residence time information including information regarding the maximum value is incorporated in the BSR and the BSR is transmitted to the base station.
   (8)

The terminal device according to any one of (2) to (7), wherein
the uplink packets are buffered for each logical channel group (LCG),
the specification unit specifies the maximum value of the residence times for each LCG, and
the transmission unit transmits the residence time information including information regarding the maximum value of the residence times for each LCG to the base station.
   (9)

The terminal device according to any one of (2) to (8), wherein
the specification unit specifies an average value of the residence times in addition to the maximum value of the residence times, and
the transmission unit transmits the residence time information including at least information regarding the maximum value of the residence times and information regarding the average value of the residence times to the base station.
   (10)

The terminal device according to (9), wherein
the uplink packets are buffered for each logical channel group (LCG),
the specification unit specifies the average value of the residence times for each LCG, and
the transmission unit transmits the residence time information including information regarding the average value of the residence times for each LCG to the base station.
   (11)

The terminal device according to any one of (2) to (10), wherein
the specification unit specifies a predicted value of the residence time in addition to the maximum value of the residence times, and
the transmission unit transmits the residence time information including at least information regarding the maximum value of the residence times and information regarding the predicted value of the residence time to the base station.
   (12)

The terminal device according to (11), wherein
the uplink packets are buffered for each logical channel group (LCG),
the specification unit specifies the predicted value of the residence time for each LCG, and
the transmission unit transmits the residence time information including information regarding the predicted value of the residence time for each LCG to the base station.
   (13)

The terminal device according to any one of (2) to (12), wherein
the specification unit specifies a residence time and an information amount for each of the uplink packets in addition to the maximum value of the residence times, and
the transmission unit transmits the residence time information including at least information regarding the maximum value of the residence times and information regarding the residence time and the information amount for each of the uplink packets to the base station.
   (14)

The terminal device according to (13), wherein
the uplink packets are buffered for each logical channel group (LCG), and
the transmission unit transmits the residence time information for each LCG to the base station.
   (15)

The terminal device according to any one of (2) to (14), wherein
the transmission unit transmits the residence time information to the base station.
   (16)

The terminal device according to (15), wherein
the transmission unit incorporates the residence time information in a BSR and transmits the BSR to the base station.
   (17)

The terminal device according to any one of (2) to (16), wherein
the transmission unit transmits the residence time information to the base station every time the transmission unit transmits the uplink packet to the base station.
   (18)

A base station connected to a terminal device, the base station comprising:
a reception unit that receives, from the terminal device, residence time information including at least information regarding a maximum value of residence times of one or more packets transmitted by the terminal device; and
a scheduling unit that performs scheduling for uplink communication of the terminal device based on the residence time information.
   (19)

A communication method executed by a terminal device connected to a base station, the communication method comprising:
measuring residence times of one or more packets transmitted by the terminal device for the respective packets;
specifying a maximum value of the residence times; and
transmitting residence time information including at least information regarding the maximum value of the residence times to the base station.
   (20)

A communication method executed by a base station connected to a terminal device, the communication method comprising:
receiving, from the terminal device, residence time information including at least information regarding a maximum value of residence times of one or more packets transmitted by the terminal device; and
performing scheduling for uplink communication of the terminal device based on the residence time information.
   (21)

A terminal device, comprising:
circuitry configured to
determine a maximum residence time of packets stored in a packet buffer of the terminal device, and
transmit residence information, including the maximum residence time, to a base station device with which the terminal device communicates.
   (22)

The terminal device according to (21), wherein
the circuitry is configured to determine the maximum residence time of packets for each of a plurality of logical channels.
   (23)

The terminal device according to (22),
wherein the residence information transmitted to the base station device includes maximum residence times for each of the plurality of logical channels.
   (24)

The terminal device according to any one of (21) to (23),
wherein the circuitry is further configured to determine the maximum residence time upon completion of transmission of a packet.
   (25)

The terminal device according to any one of (21) to (24),
wherein the circuitry is further configured to transmit the residence information with each packet transmission.
   (26)

The terminal device according to any one of (21) to (25),
wherein the circuitry is further configured to
determine an average residence time which is an average of residence times of all packets stored in the buffer, and
transmit the average residence time with the maximum residence time as part of the residence information.
   (27)

The terminal device according to any one of (21) to (26),
wherein the circuitry is further configured to
determine a predicted residence time which is a future value of residence times, and

transmit the predicted residence time as part of the residence information.

(28)

The terminal device according to (27),
wherein the circuitry is configured to input measured residence time values into a neural network in order to cause the neural network to generate the predicted residence time.
   (29)

The terminal device according to any one of (21) to (28),
wherein the residence information is included in a buffer status report (BSR).
   (30)

The terminal device according to (29),
wherein the BSR includes a dedicated area for reporting the maximum residence time.
   (31)

The terminal device according to (30),
wherein the dedicated area of the BSR is provided as new octets appended to existing octets of the BSR, and each logical channel has a corresponding octet in the new octets.
   (32)

The terminal device according to (31),
wherein, in a case of a short-format BSR, an identifier of a logical channel and a corresponding buffer size are included in a single existing octet, and the residence information is included in a new octet appended to the existing octet.
   (33)

The terminal device according to (31) or (32),
wherein, in a case of a long-format BSR, the new octets corresponding to the residence information are appended after existing octets of the BSR that correspond to buffer size.
   (34)

The terminal device according to (30),
wherein, in a case of a short-format BSR, an identifier of a logic channel, a buffer size corresponding to the logic channel, and residency information corresponding to the logic channel are included in a same octet of the BSR.
   (35)

The terminal device according to (30) or (34),
wherein, in a case of a long-format BSR, a buffer size and residence information for a same logic channel are included in a same octet of the BSR.
   (36)

The terminal device according to any one of (21) to (35),
wherein the circuitry is configured to transmit the residence information upon receipt of a scheduling grant from the base station device.
   (37)

The terminal device according to (21) to (36),
wherein the circuitry determines the maximum residence time based on at least one of a time from creation of a packet at an external device, a time from generation of the packet by an application on the terminal device, and a time from arrival of the packet at a predetermined protocol level.
   (38)

The terminal device according to (37),
wherein the external device is a camera.
   (39)

The terminal device according to (21) to (38),
wherein the residence information includes residence times for each packet stored in the buffer in addition to the maximum residence time.
   (40)

A base station device, comprising:
circuitry configured to
receive residence information from a terminal device with which the base station device communicates, the residence information including at least a maximum residence time of packets stored in the terminal device, and
notify the terminal device of at least one scheduling grant based on the maximum residence time.
   (41)

A method for a terminal device that communicates with a base station device, the method comprising:
determining, with circuitry, a maximum residence time of packets stored in a packet buffer of the terminal device, and
transmitting residence information, including the maximum residence time, to the base station device.

(42)

A method for a base station device that communicates with a terminal device, the method comprising:
receiving, with circuitry, residence information from the terminal device, the residence information including at least a maximum residence time of packets stored in the terminal device, and
notify the terminal device of at least one scheduling grant based on the maximum residence time.

### REFERENCE SIGNS LIST

1 Communication system
10 Server
20 Management device
30 Base station
40 Terminal device
11, 21 Communication unit
31, 41 Wireless communication unit
12, 22, 32, 42 Storage unit
13, 23, 33, 43 Control unit
44 External interface
311, 411 Transmission processing unit
312, 412 Reception processing unit
313, 413 Antenna
331, 431 Transmission unit
332, 432 Reception unit
333 Scheduling unit
433 Measurement unit
434 Specification unit
RAN Radio access network
CN Core network

1. A terminal device, comprising:
circuitry configured to
determine a maximum residence time of packets stored in a packet buffer of the terminal device, and
transmit residence information, including the maximum residence time, to a base station device with which the terminal device communicates.

2. The terminal device according to claim 1, wherein
the circuitry is configured to determine the maximum residence time of packets for each of a plurality of logical channels.

3. The terminal device according to claim 2, wherein
the residence information transmitted to the base station device includes maximum residence times for each of the plurality of logical channels.

4. The terminal device according to claim 1, wherein
the circuitry is further configured to determine the maximum residence time upon completion of transmission of a packet.

5. The terminal device according to claim 1, wherein
the circuitry is further configured to transmit the residence information with each packet transmission.

6. The terminal device according to claim 1, wherein
the circuitry is further configured to
determine an average residence time which is an average of residence times of all packets stored in the buffer, and
transmit the average residence time with the maximum residence time as part of the residence information.

7. The terminal device according to claim 1, wherein
the circuitry is further configured to
determine a predicted residence time which is a future value of residence times, and
transmit the predicted residence time as part of the residence information.

8. The terminal device according to claim 1, wherein
the residence information is included in a buffer status report (BSR).

9. The terminal device according to claim 8, wherein
the BSR includes a dedicated area for reporting the maximum residence time.

10. The terminal device according to claim 9, wherein
the dedicated area of the BSR is provided as new octets appended to existing octets of the BSR, and each logical channel has a corresponding octet in the new octets.

11. The terminal device according to claim 10, wherein,
in a case of a short-format BSR, an identifier of a logical channel and a corresponding buffer size are included in a single existing octet, and
the residence information is included in a new octet appended to the existing octet.

12. The terminal device according to claim 10, wherein,
in a case of a long-format BSR, the new octets corresponding to the residence information are appended after existing octets of the BSR that correspond to buffer size.

13. The terminal device according to claim 9, wherein,
in a case of a short-format BSR, an identifier of a logic channel, a buffer size corresponding to the logic channel, and residency information corresponding to the logic channel are included in a same octet of the BSR.

14. The terminal device according to claim 9, wherein,
in a case of a long-format BSR, a buffer size and residence information for a same logic channel are included in a same octet of the BSR.

15. The terminal device according to claim 1, wherein
the circuitry is configured to transmit the residence information upon receipt of a scheduling grant from the base station device.

16. The terminal device according to claim 1, wherein
the circuitry determines the maximum residence time based on at least one of a time from creation of a packet at an external device, a time from generation of the packet by an application on the terminal device, and a time from arrival of the packet at a predetermined protocol level.

17. The terminal device according to claim 1, wherein
the residence information includes residence times for each packet stored in the buffer in addition to the maximum residence time.

18. A base station device, comprising:
circuitry configured to
receive residence information from a terminal device with which the base station device communicates, the residence information including at least a maximum residence time of packets stored in the terminal device, and
notify the terminal device of at least one scheduling grant based on the maximum residence time.

19. A method for a terminal device that communicates with a base station device, the method comprising:
determining, with circuitry, a maximum residence time of packets stored in a packet buffer of the terminal device, and
transmitting residence information, including the maximum residence time, to the base station device.

20. A method for a base station device that communicates with a terminal device, the method comprising:
receiving, with circuitry, residence information from the terminal device, the residence information including at least a maximum residence time of packets stored in the terminal device, and
notify the terminal device of at least one scheduling grant based on the maximum residence time.
